(19) United States
(12) Patent Application Publication
(10) Pub. No.: US 2021/0263538 A1
(43) Pub. Date: Aug. 26, 2021

(54) UNMANNED AERIAL VEHICLE AND UNMANNED AERIAL VEHICLE SYSTEM

(71) Applicant: LG ELECTRONICS INC., Seoul (KR)

(72) Inventors: Pilwon Kwak, Seoul (KR); Daeun KIM, Seoul (KR); Jeongkyo SEO, Seoul (KR)

(21) Appl. No.: 17/131,083

(22) Filed: Dec. 22, 2020

(30) Foreign Application Priority Data
Dec. 23, 2019 (KR) 10-2019-0173239

(51) Int. Cl. G05D 1/10; G08G 5/00; B64C 39/02

(52) U.S. Cl. CPC G05D 1/104; G08G 5/0008; B64C 2201/143; B64C 2201/12; B64C 2201/024; B64C 39/024

(57) ABSTRACT

According to an embodiment of the present invention, an unmanned aerial vehicle (UAV) may recognize at least some of the light output from light sources of other unmanned aerial vehicles in swarm flight, and correct the location error based on the recognized light. An unmanned aerial vehicle (UAV) according to an embodiment of the present invention may be linked to an Artificial Intelligence module, a robot, a device related to a 5G service, and the like.

### CROSS-REFERENCE TO RELATED APPLICATION(S)

This application claims the priority benefit of Korean Patent Application No. 10-2019-0173239, filed in Korea on Dec. 23, 2019 in the Korean Intellectual Property Office, the disclosure of which is incorporated herein by reference.

### BACKGROUND

### 1. Field

The present invention relates to an unmanned aerial vehicle and an unmanned aerial vehicle system, and more particularly to technology of the unmanned aerial vehicle capable of performing swarm flight.

### 2. Background

An unmanned aerial vehicle generally refers to an aircraft and a helicopter-shaped unmanned aerial vehicle/uninhabited aerial vehicle (UAV) capable of a flight and pilot by the induction of a radio wave without a pilot. A recent unmanned aerial vehicle is increasingly used in various civilian and commercial fields, such as image photographing, unmanned delivery service, and disaster observation, in addition to military use such as reconnaissance and an attack.

As an operation method of such unmanned aerial vehicle, it can be operated through an unmanned aerial control system including a vehicle that is remotely piloted from the ground, autonomously flies in an automatic or semi-auto-piloted format according to a pre-programmed route, or performs missions according to its own environmental judgment by mounting artificial intelligence, Ground Control Station/System(GCS) and communication(data link) support equipments.

According to the development of unmanned aerial vehicle technology, research on swarm flight using multiple unmanned aerial vehicles is also increasing.

### BRIEF DESCRIPTION OF THE DRAWINGS

Embodiments will be described in detail with reference to the following drawings in which like reference numerals refer to like elements, and wherein:

FIG. 1 shows a perspective view of an unmanned aerial vehicle to which a method proposed in the specification is applicable;

FIG. 2 is a block diagram showing a control relation between major elements of the unmanned aerial vehicle of FIG. 1;

FIG. 3 is a block diagram showing a control relation between major elements of an aerial control system according to an embodiment of the present invention;

FIG. 4 illustrates a block diagram of a wireless communication system to which methods proposed in the specification are applicable;

FIG. 5 is a diagram showing an example of a signal transmission/reception method in a wireless communication system;

FIG. 6 shows an example of a basic operation of a robot and a 5G network in a 5G communication system;

FIG. 7 illustrates an example of a basic operation between robots using 5G communication;

FIG. 8 is a diagram showing an example of the concept diagram of a 3GPP system including a UAS;

FIG. 9 shows examples of a C2 communication model for a UAV;

FIG. 10 is a flowchart showing an example of a measurement execution method to which the present invention is applicable;

FIGS. 11 and 12 are views referenced for explanation of an example of using an unmanned aerial vehicle according to an embodiment of the present invention in the field of building construction;

FIGS. 13A and 13B are views referenced for explanation of an example of using a building construction field for swarm flight of unmanned aerial vehicles according to an embodiment of the present invention;

FIGS. 14 to 17 are views referenced for explanation of arrangement of unmanned aerial vehicles using light during swarm flight according to an embodiment of the present invention;

FIG. 18 is a view referenced for explanation of mutual error correction during swarm flight according to an embodiment of the present invention;

FIG. 19 is a flowchart illustrating a method of correcting a location error during a swarm flight according to an embodiment of the present invention;

FIG. 20 is a diagram referenced for explanation of the location error correction method of FIG. 19;

FIG. 21 is a flowchart illustrating a method of correcting a location error during a swarm flight according to an embodiment of the present invention;

FIG. 22 is a diagram referenced for explanation of the location error correction method of FIG. 21;

FIG. 23 is a flowchart illustrating a method of correcting a location error during a swarm flight according to an embodiment of the present invention;

FIG. 24 is a diagram referenced for explanation of the location error correction method of FIG. 23;

FIGS. 25 and 26 are views referenced for explanation of a method for forming a swarm flight formation according to an embodiment of the present invention;

FIGS. 27 to 29 are diagrams referenced for description of distance determination methods according to various embodiments of the present disclosure;

FIG. 30 is a diagram referenced for explanation of arrangement of an unmanned aerial vehicle using a laser;

FIG. 31 shows a block diagram of a wireless communication device according to an embodiment of the present invention; and

FIG. 32 is a block diagram of a communication device according to an embodiment of the present invention.

### DETAILED DESCRIPTION

Reference will now be made in detail to embodiments, examples of which are illustrated in the accompanying drawings. However, the present invention may be embodied in many different forms and should not be construed as being limited to the embodiments set forth herein.

Meanwhile, in the following description, with respect to constituent elements used in the following description, the suffixes “module” and “unit” are used or combined with each other only in consideration of ease in preparation of the specification, and do not have or indicate mutually different meanings. Accordingly, the suffixes “module” and “unit” may be used interchangeably.

Also, it will be understood that although the terms “first,” “second,” etc., may be used herein to describe various components, these components should not be limited by these terms. These terms are only used to distinguish one component from another component.

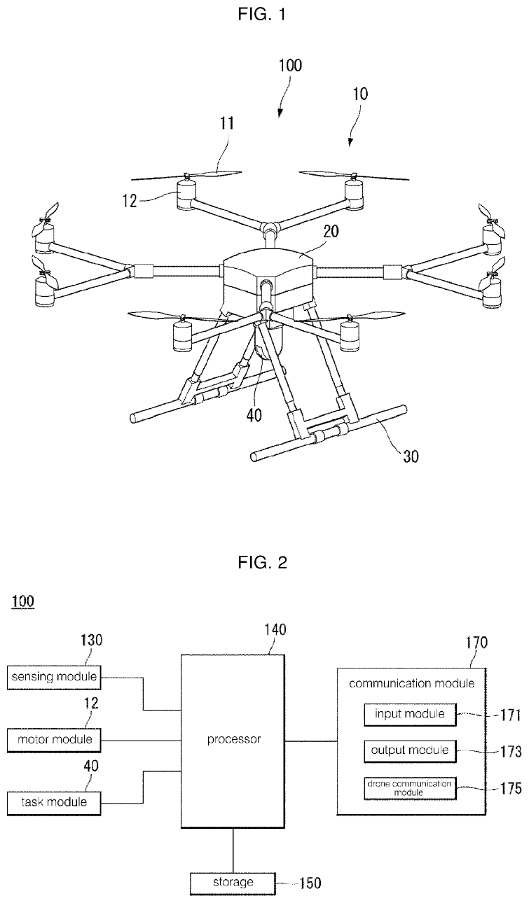

FIG. 1 shows a perspective view of an unmanned aerial vehicle to which a method proposed in the specification is applicable.

FIG. 1 shows a perspective view of an unmanned aerial vehicle according to an embodiment of the present invention.

First, the unmanned aerial vehicle 100 is manually manipulated by an administrator on the ground, or it flies in an unmanned manner while it is automatically piloted by a configured flight program. The unmanned aerial vehicle 100, as in FIG. 1, includes a main body 20, a horizontal and vertical movement propulsion device 10, and landing legs 130.

The main body 20 is a body portion on which a module, such as a task module 40, is mounted.

The unmanned aerial vehicle 100 may include a task module 40 that performs a predetermined task.

As an example, the task module 40 may be provided to perform a photographing operation with a camera for photographing an image.

As another example, the task module 40 may be equipped with equipment to assist in precise construction at a construction site. For example, the task module 40 may include a laser for a guide at a construction site, a camera for monitoring a construction site, and the like.

As another example, the task module 40 may be provided to perform a transport operation of objects and people.

As another example, the task module 40 may perform a security function that detects an external intruder or a dangerous situation. The task module 40 may be equipped with a camera for performing such a security function.

There may be various examples of the types of work of the task module 40, and there is no need to be limited to the examples of this description. In addition, the unmanned aerial vehicle 100 may perform a plurality of tasks, and the task module 40 may be provided with modules and equipment for a plurality of tasks performed by the unmanned aerial vehicle 100.

The horizontal and vertical movement propulsion device 10 includes one or more propellers 11 positioned vertically to the main body 20. The horizontal and vertical movement propulsion device 10 according to an embodiment of the present invention includes a plurality of propellers 11 and motors 12, which are spaced apart. In this case, the horizontal and vertical movement propulsion device 10 may have an air jet propeller structure not the propeller 11.

A plurality of propeller supports is radially formed in the main body 20. The motor 12 may be mounted on each of the propeller supports. The propeller 11 is mounted on each motor 12.

The plurality of propellers 11 may be disposed symmetrically with respect to the main body 20. Furthermore, the rotation direction of the motor 12 may be determined so that the clockwise and counterclockwise rotation directions of the plurality of propellers 11 are combined. The rotation direction of one pair of the propellers 11 symmetrical with respect to the main body 20 may be set identically (e.g., clockwise). Furthermore, the other pair of the propellers 11 may have a rotation direction opposite (e.g., counterclockwise) that of the one pair of the propellers 11.

The landing legs 30 are disposed with being spaced apart at the bottom of the main body 20. Furthermore, a buffering support member (not shown) for minimizing an impact attributable to a collision with the ground when the unmanned aerial vehicle 100 makes a landing may be mounted on the bottom of the landing leg 30.

The unmanned aerial vehicle 100 may have various aerial vehicle structures different from that described above.

FIG. 2 is a block diagram showing a control relation between major elements of the unmanned aerial vehicle of FIG. 1.

Referring to FIG. 2, the unmanned aerial vehicle 100 measures its own flight state using a variety of types of sensors in order to fly stably.

The unmanned aerial vehicle 100 may include a sensing module 130 including at least one sensor.

The flight state of the unmanned aerial vehicle 100 is defined as rotational states and translational states.

The rotational states mean “yaw”, “pitch”, and “roll.” The translational states mean longitude, latitude, altitude, and velocity.

In this case, “roll”, “pitch”, and “yaw” are called Euler angle, and indicate that the x, y, z three axes of an aircraft body frame coordinate have been rotated with respect to a given specific coordinate, for example, three axes of NED coordinates N, E, D. If the front of an aircraft is rotated left and right on the basis of the z axis of a body frame coordinate, the x axis of the body frame coordinate has an angle difference with the N axis of the NED coordinate, and this angle is called “yaw” (ψ). If the front of an aircraft is rotated up and down on the basis of the y axis toward the right, the z axis of the body frame coordinate has an angle difference with the D axis of the NED coordinates, and this angle is called a “pitch” (θ). If the body frame of an aircraft is inclined left and right on the basis of the x axis toward the front, the y axis of the body frame coordinate has an angle to the E axis of the NED coordinates, and this angle is called “roll” (ϕ).

The unmanned aerial vehicle 100 uses 3-axis gyroscopes, 3-axis accelerometers, and 3-axis magnetometers in order to measure the rotational states, and uses a GPS sensor and a barometric pressure sensor in order to measure the translational states.

The sensing module 130 of the present invention includes at least one of the gyroscopes, the accelerometers, the GPS sensor, the image sensor or the barometric pressure sensor. In this case, the gyroscopes and the accelerometers measure the states in which the body frame coordinates of the unmanned aerial vehicle 100 have been rotated and accelerated with respect to earth centered inertial coordinate. The gyroscopes and the accelerometers may be fabricated as a single chip called an inertial measurement module (IMU) using a micro-electro-mechanical systems (MEMS) semiconductor process technology.

Furthermore, the IMU chip may include a microcontroller for converting measurement values based on the earth centered inertial coordinates, measured by the gyroscopes and the accelerometers, into local coordinates, for example, north-east-down (NED) coordinates used by GPSs.

The gyroscopes measure angular velocity at which the body frame coordinate x, y, z three axes of the unmanned aerial vehicle 100 rotate with respect to the earth centered inertial coordinates, calculate values (Wx.gyro, Wy.gyro, Wz.gyro) converted into fixed coordinates, and convert the values into Euler angles (ϕgyro, θgyro, ψgyro) using a linear differential equation.

The accelerometers measure acceleration for the earth centered inertial coordinates of the body frame coordinate x, y, z three axes of the unmanned aerial vehicle 100, calculate values (fx,acc, fy,acc, fz,acc) converted into fixed coordinates, and convert the values into “roll (ϕacc)” and “pitch (θacc).” The values are used to remove a bias error included in “roll (ϕgyro)” and “pitch (θgyro)” using measurement values of the gyroscopes.

The magnetometers measure the direction of magnetic north points of the body frame coordinate x, y, z three axes of the unmanned aerial vehicle 100, and calculate a “yaw” value for the NED coordinates of body frame coordinates using the value.

The GPS sensor calculates the translational states of the unmanned aerial vehicle 100 on the NED coordinates, that is, a latitude (Pn.GPS), a longitude (Pe.GPS), an altitude (hMSL.GPS), velocity (Vn.GPS) on the latitude, velocity (Ve.GPS) on longitude, and velocity (Vd.GPS) on the altitude, using signals received from GPS satellites. In this case, the subscript MSL means a mean sea level (MSL).

The barometric pressure sensor may measure the altitude (hALP.baro) of the unmanned aerial vehicle 100. In this case, the subscript ALP means an air-level pressor. The barometric pressure sensor calculates a current altitude from a take-off point by comparing an air-level pressor when the unmanned aerial vehicle 100 takes off with an air-level pressor at a current flight altitude.

The camera sensor may include an image sensor (e.g., CMOS image sensor), including at least one optical lens and multiple photodiodes (e.g., pixels) on which an image is focused by light passing through the optical lens, and a digital signal processor (DSP) configuring an image based on signals output by the photodiodes. The DSP may generate a moving image including frames configured with a still image, in addition to a still image.

The unmanned aerial vehicle 100 includes a communication module 170 for inputting or receiving information or outputting or transmitting information. The communication module 170 may include a drone communication module 175 for transmitting/receiving information to/from a different external device. The communication module 170 may include an input module 171 for inputting information. The communication module 170 may include an output module 173 for outputting information.

The output module 173 may be omitted from the unmanned aerial vehicle 100, and may be formed in a terminal 300.

For example, the unmanned aerial vehicle 100 may directly receive information from the input module 171. For another example, the unmanned aerial vehicle 100 may receive information, input to a separate terminal 300 or server 200, through the drone communication module 175.

For example, the unmanned aerial vehicle 100 may directly output information to the output module 173. For another example, the unmanned aerial vehicle 100 may transmit information to a separate terminal 300 through the drone communication module 175 so that the terminal 300 outputs the information.

The drone communication module 175 may be provided to communicate with an external server 200, an external terminal 300, etc. The drone communication module 175 may receive information input from the terminal 300, such as a smartphone or a computer. The drone communication module 175 may transmit information to be transmitted to the terminal 300. The terminal 300 may output information received from the drone communication module 175.

The drone communication module 175 may receive various command signals from the terminal 300 or/and the server 200. The drone communication module 175 may receive area information for driving, a driving route, or a driving command from the terminal 300 or/and the server 200. In this case, the area information may include flight restriction area (A) information and approach restriction distance information.

The input module 171 may receive On/Off or various commands. The input module 171 may receive area information. The input module 171 may receive object information. The input module 171 may include various buttons or a touch pad or a microphone.

The output module 173 may notify a user of various pieces of information. The output module 173 may include a speaker and/or a display. The output module 173 may output information on a discovery detected while driving. The output module 173 may output identification information of a discovery. The output module 173 may output location information of a discovery.

The unmanned aerial vehicle 100 includes a processor 140 for processing and determining various pieces of information, such as mapping and/or a current location. The processor 140 may control an overall operation of the unmanned aerial vehicle 100 through control of various elements that configure the unmanned aerial vehicle 100.

The processor 140 may receive information from the communication module 170 and process the information. The processor 140 may receive information from the input module 171, and may process the information. The processor 140 may receive information from the drone communication module 175, and may process the information.

The processor 140 may receive sensing information from the sensing module 130, and may process the sensing information.

The processor 140 may control the driving of the motor module 12. The motor module 12 may each include one or more motors and other components necessary for driving the motor.

The processor 140 may control the operation of the task module 40.

The unmanned aerial vehicle 100 includes a storage 150 for storing various data. The storage 150 records various pieces of information necessary for control of the unmanned aerial vehicle 100, and may include a volatile or non-volatile recording medium.

A map for a driving area may be stored in the storage 150. The map may have been input by the external terminal 300 capable of exchanging information with the unmanned aerial vehicle 100 through the drone communication module 175, or may have been autonomously learnt and generated by the unmanned aerial vehicle 100. In the former case, the external terminal 300 may include a remote controller, a PDA, a laptop, a smartphone or a tablet on which an application for a map configuration has been mounted, for example.

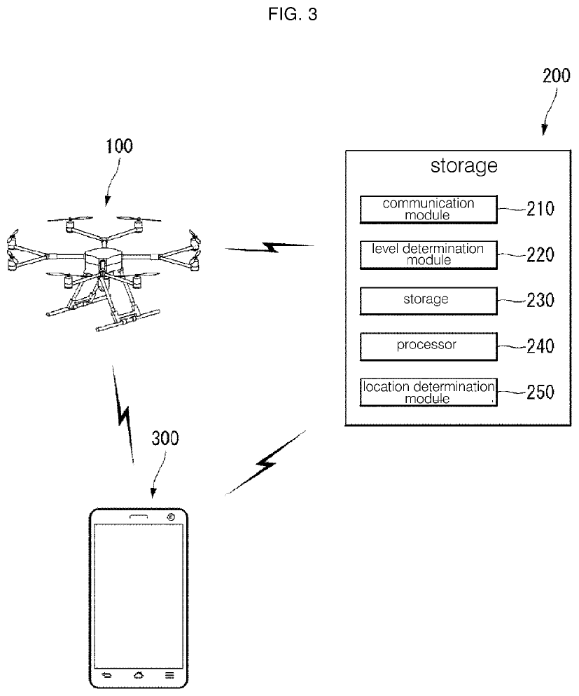

FIG. 3 is a block diagram showing a control relation between major elements of an aerial control system according to an embodiment of the present invention.

Referring to FIG. 3, the aerial control system according to an embodiment of the present invention may include the unmanned aerial vehicle 100 and the server 200, or may include the unmanned aerial vehicle 100, the terminal 300, and the server 200.

The terminal 300 may include a controller that receives a control command for controlling the unmanned aerial vehicle 100 and an output unit that outputs visual or auditory information.

The server 200 stores information on the restricted flight area in which flight of the unmanned aerial vehicle 100 is restricted, calculates the access restriction distance of the restricted flight area differently according to the autonomous driving level of the unmanned aerial vehicle 100, and provides information on a restricted flight area and information on a restricted access distance to at least one of the unmanned aerial vehicle 100 and the terminal 300. Therefore, in the case of the unmanned aerial vehicle 100 having a high autonomous driving level, an efficient route is driven, and in the case of the unmanned vehicle 100 having a low autonomous driving level, the unmanned aerial vehicle 100 having a low level of autonomous driving is close to the flight restriction area. There is an advantage that can prevent accidents that may occur.

In addition, the server 200 may set a flight path based on the flight restriction area information and the access restriction distance information, and provide the flight route to at least one of the unmanned aerial vehicle 100 and the terminal 300.

Actively, the server 200 may set a flight path based on the flight restriction area information and the access restriction distance information according to the autonomous driving level, and control the unmanned aerial vehicle 100 according to the flight route.

When the unmanned aerial vehicle 100 approaches within the restricted access distance, the server 200 may transmit different commands to the unmanned aerial vehicle 100 according to the autonomous driving level. The server 200 may transmit different commands to the unmanned aerial vehicle 100 whether automatic or manual adjustment of the unmanned aerial vehicle 100 is performed.

For example, the server 200 may include a communication module 210 that exchanges information with the unmanned aerial vehicle 100 and/or the terminal 300, a level determination module 220 that determines the autonomous driving level of the unmanned aerial vehicle 100, a storage 230 that stores information on the restricted flight area in which flight of the unmanned aerial vehicle 100 is restricted, and a processor 240 that provides information to the unmanned aerial vehicle 100 and/or a terminal 300 or controls the unmanned aerial vehicle 100 and/or the terminal 300. In addition, the server 200 may further include a location determination module 250 that determines the location and altitude of the unmanned aerial vehicle 100 through the location and altitude information provided from the unmanned aerial vehicle 100.

The storage 230 may store information on the unmanned aerial vehicle 100 and/or the terminal 200. In addition, the port storage 230 stores information on the restricted flight area for public control, stores information on the autonomous driving level of the unmanned aerial vehicle 100, and provides information on air control of the unmanned aerial vehicle 100 Can be saved.

The level determination module 220 determines the autonomous driving level of the unmanned aerial vehicle 100. The autonomous driving level of the unmanned aerial vehicle 100 is determined through autonomous driving level information transmitted from the unmanned aerial vehicle 100 to the server 200 or through autonomous driving level information provided from the terminal 300.

The autonomous driving level of the unmanned aerial vehicle 100 is defined as level 1, which is the level of fully manual driving only, or the level of assisting manual driving with various sensors. And the autonomous driving level of the unmanned aerial vehicle 100 is defined as level 2, which is the level of the unmanned aerial vehicle 100 is semi-autonomous driving (automatic take-off and landing, passive obstacle avoidance, moving according to the route specified by the user). And level 3 is the level at which the unmanned aerial vehicle 100 is completely autonomous (creating a route by itself, moving to the destination (S2), and performing tasks by itself).

The processor 240 calculates the access restriction distance of the flight restricted area differently according to the autonomous driving level of the unmanned aerial vehicle 100, and provides the flight restriction area information and the access restriction distance information to the unmanned aerial vehicle 100 and/or the terminal 300.

The information on the restricted flight area may include location information of the restricted flight area and boundary information of the restricted flight area.

The processor 240 may transmit different commands to the unmanned aerial vehicle 100 according to the autonomous driving level when the unmanned aerial vehicle 100 approaches within the restricted access distance. Accordingly, it is possible to induce efficient driving in the flight restricted area and prevent accidents according to the autonomous driving level.

The unmanned aerial vehicle 100, the terminal 300, and the server 200 are interconnected using a wireless communication method.

Global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), etc. may be used as the wireless communication method.

A wireless Internet technology may be used as the wireless communication method. The wireless Internet technology includes a wireless LAN (WLAN), wireless-fidelity (Wi-Fi), wireless fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and 5G, for example. In particular, a faster response is possible by transmitting/receiving data using a 5G communication network.

In the specification, a base station has a meaning as a terminal node of a network that directly performs communication with a terminal. In the specification, a specific operation illustrated as being performed by a base station may be performed by an upper node of the base station in some cases. That is, it is evident that in a network configured with a plurality of network nodes including a base station, various operations performed for communication with a terminal may be performed by the base station or different network nodes other than the base station. A “base station (BS)” may be substituted with a term, such as a fixed station, a Node B, an evolved-NodeB (eNB), a base transceiver system (BTS), an access point (AP), or a next generation NodeB (gNB). Furthermore, a “terminal” may be fixed or may have mobility, and may be substituted with a term, such as a user equipment (UE), a mobile station (MS), a user terminal (UT), a mobile subscriber station (MSS), a subscriber station (SS), an advanced mobile station (AMS), a wireless terminal (WT), a machine-type communication (MTC) device, a machine-to-machine (M2M) device, or a device-to-device (D2D) device.

Hereinafter, downlink (DL) means communication from a base station to a terminal. Uplink (UL) means communication from a terminal to a base station. In the downlink, a transmitter may be part of a base station, and a receiver may be part of a terminal. In the uplink, a transmitter may be part of a terminal, and a receiver may be part of a base station.

Specific terms used in the following description have been provided to help understanding of the present invention. The use of such a specific term may be changed into another form without departing from the technical spirit of the present invention.

Embodiments of the present invention may be supported by standard documents disclosed in at least one of IEEE 802, 3GPP and 3GPP2, that is, radio access systems. That is, steps or portions not described in order not to clearly disclose the technical spirit of the present invention in the embodiments of the present invention may be supported by the documents. Furthermore, all terms disclosed in this document may be described by the standard documents.

In order to clarity the description, 3GPP 5G is chiefly described, but the technical characteristic of the present invention is not limited thereto.

UE and 5G network block diagram example

FIG. 4 illustrates a block diagram of a wireless communication system to which methods proposed in the specification are applicable.

Referring to FIG. 4, a drone is defined as a first communication device (410 of FIG. 4). A processor 411 may perform a detailed operation of the unmanned aerial vehicle.

The unmanned aerial vehicle e may be represented as a drone or an unmanned aerial robot.

A 5G network communicating with a drone may be defined as a second communication device (420 of FIG. 4). A processor 421 may perform a detailed operation of the drone. In this case, the 5G network may include another drone communicating with the drone.

A 5G network maybe represented as a first communication device, and a drone may be represented as a second communication device.

For example, the first communication device or the second communication device may be a base station, a network node, a transmission terminal, a reception terminal, a wireless apparatus, a wireless communication device or a drone.

For example, a terminal or a user equipment (UE) may include a drone, an unmanned aerial vehicle (UAV), a mobile phone, a smartphone, a laptop computer, a terminal for digital broadcasting, personal digital assistants (PDA), a portable multimedia player (PMP), a navigator, a slate PC, a tablet PC, an ultrabook, a wearable device (e.g., a watch type terminal (smartwatch), a glass type terminal (smart glass), and a head mounted display (HMD). For example, the HMD may be a display device of a form, which is worn on the head. For example, the HMD may be used to implement VR, AR or MR. Referring to FIG. 4, the first communication device 410, the second communication device 420 includes a processor 411, 421, a memory 414, 424, one or more Tx/Rx radio frequency (RF) modules 415, 425, a Tx processor 412, 422, an Rx processor 413, 423, and an antenna 416, 426. The Tx/Rx module is also called a transceiver. Each Tx/Rx module 415 transmits a signal each antenna 426. The processor implements the above-described function, process and/or method. The processor 421 may be related to the memory 424 for storing a program code and data. The memory may be referred to as a computer-readable recording medium. More specifically, in the DL (communication from the first communication device to the second communication device), the transmission (TX) processor 912 implements various signal processing functions for the L1 layer (i.e., physical layer). The reception (RX) processor implements various signal processing functions for the L1 layer (i.e., physical layer).

UL (communication from the second communication device to the first communication device) is processed by the first communication device 410 using a method similar to that described in relation to a receiver function in the second communication device 420. Each Tx/Rx module 425 receives a signal through each antenna 426. Each Tx/Rx module provides an RF carrier and information to the RX processor 923. The processor 421 may be related to the memory 424 for storing a program code and data. The memory may be referred to as a computer-readable recording medium.

Signal Transmission/Reception Method in Wireless Communication System

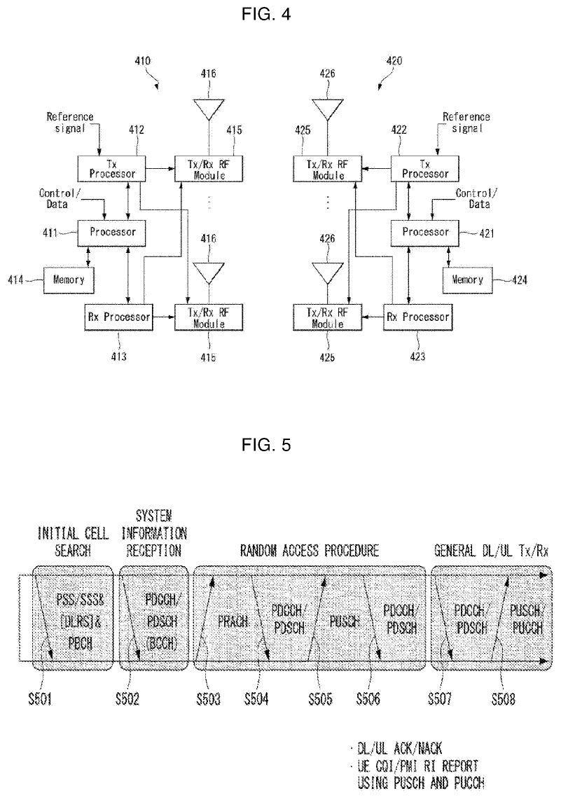

FIG. 5 is a diagram showing an example of a signal transmission/reception method in a wireless communication system.

FIG. 5 shows the physical channels and general signal transmission used in a 3GPP system. In the wireless communication system, the terminal receives information from the base station through the downlink (DL), and the terminal transmits information to the base station through the uplink (UL). The information which is transmitted and received between the base station and the terminal includes data and various control information, and various physical channels exist according to a type/usage of the information transmitted and received therebetween.

When power is turned on or the terminal enters a new cell, the terminal performs initial cell search operation such as synchronizing with the base station (S201). To this end, the terminal may receive a primary synchronization signal (PSS) and a secondary synchronization signal (SSS) from the base station to synchronize with the base station and obtain information such as a cell ID. Thereafter, the terminal may receive a physical broadcast channel (PBCH) from the base station to obtain broadcast information in a cell. Meanwhile, the terminal may check a downlink channel state by receiving a downlink reference signal (DL RS) in an initial cell search step.

After the terminal completes the initial cell search, the terminal may obtain more specific system information by receiving a physical downlink control channel (PDSCH) according to a physical downlink control channel (PDCCH) and information on the PDCCH (S202).

When the terminal firstly connects to the base station or there is no radio resource for signal transmission, the terminal may perform a random access procedure (RACH) for the base station (S203 to S206). To this end, the terminal may transmit a specific sequence to a preamble through a physical random access channel (PRACH) (S203 and S205), and receive a response message (RAR (Random Access Response) message) for the preamble through the PDCCH and the corresponding PDSCH. In case of a contention-based RACH, a contention resolution procedure may be additionally performed (S206).

After the terminal performs the procedure as described above, as a general uplink/downlink signal transmission procedure, the terminal may perform a PDCCH/PDSCH reception (S207) and physical uplink shared channel (PUSCH)/physical uplink control channel (PUCCH) transmission (S208). In particular, the terminal may receive downlink control information (DCI) through the PDCCH. Here, the DCI includes control information such as resource allocation information for the terminal, and the format may be applied differently according to a purpose of use.

Meanwhile, the control information transmitted by the terminal to the base station through the uplink or received by the terminal from the base station may include a downlink/uplink ACK/NACK signal, a channel quality indicator (CQI), a precoding matrix index (PMI), and a rank indicator (RI), or the like. The terminal may transmit the above-described control information such as CQI/PMI/RI through PUSCH and/or PUCCH.

An initial access (IA) procedure in a 5G communication system is additionally described with reference to FIG. 5.

A UE may perform cell search, system information acquisition, beam arrangement for initial access, DL measurement, etc. based on an SSB. The SSB is interchangeably used with a synchronization signal/physical broadcast channel (SS/PBCH) block.

An SSB is configured with a PSS, an SSS and a PBCH. The SSB is configured with four contiguous OFDM symbols. A PSS, a PBCH, an SSS/PBCH or a PBCH is transmitted for each OFDM symbol. Each of the PSS and the SSS is configured with one OFDM symbol and 127 subcarriers. The PBCH is configured with three OFDM symbols and 576 subcarriers.

Cell search means a process of obtaining, by a UE, the time/frequency synchronization of a cell and detecting the cell identifier (ID) (e.g., physical layer cell ID (PCI)) of the cell. A PSS is used to detect a cell ID within a cell ID group. An SSS is used to detect a cell ID group. A PBCH is used for SSB (time) index detection and half-frame detection.

There are 336 cell ID groups. 3 cell IDs are present for each cell ID group. A total of 1008 cell IDs are present. Information on a cell ID group to which the cell ID of a cell belongs is provided/obtained through the SSS of the cell. Information on a cell ID among the 336 cells within the cell ID is provided/obtained through a PSS.

An SSB is periodically transmitted based on SSB periodicity. Upon performing initial cell search, SSB base periodicity assumed by a UE is defined as 20 ms. After cell access, SSB periodicity may be set as one of {5 ms, 10 ms, 20 ms, 40 ms, 80 ms, 160 ms} by a network (e.g., BS).

Next, system information (SI) acquisition is described.

SI is divided into a master information block (MIB) and a plurality of system information blocks (SIBs). SI other than the MIB may be called remaining minimum system information (RMSI). The MIB includes information/parameter for the monitoring of a PDCCH that schedules a PDSCH carrying SystemInformationBlock1 (SIB1), and is transmitted by a BS through the PBCH of an SSB. SIB1 includes information related to the availability of the remaining SIBs (hereafter, SIBx, x is an integer of 2 or more) and scheduling (e.g., transmission periodicity, SI-window size). SIBx includes an SI message, and is transmitted through a PDSCH. Each SI message is transmitted within a periodically occurring time window (i.e., SI-window).

A random access (RA) process in a 5G communication system is additionally described with reference to FIG. 5.

A random access process is used for various purposes. For example, a random access process may be used for network initial access, handover, UE-triggered UL data transmission. A UE may obtain UL synchronization and an UL transmission resource through a random access process. The random access process is divided into a contention-based random access process and a contention-free random access process. A detailed procedure for the contention-based random access process is described below.

A UE may transmit a random access preamble through a PRACH as Msg1 of a random access process in the UL. Random access preamble sequences having two different lengths are supported. A long sequence length 839 is applied to subcarrier spacings of 1.25 and 5 kHz, and a short sequence length 139 is applied to subcarrier spacings of 15, 30, 60 and 120 kHz.

When a BS receives the random access preamble from the UE, the BS transmits a random access response (RAR) message (Msg2) to the UE. A PDCCH that schedules a PDSCH carrying an RAR is CRC masked with a random access (RA) radio network temporary identifier (RNTI) (RA-RNTI), and is transmitted. The UE that has detected the PDCCH masked with the RA-RNTI may receive the RAR from the PDSCH scheduled by DCI carried by the PDCCH. The UE identifies whether random access response information for the preamble transmitted by the UE, that is, Msg1, is present within the RAR. Whether random access information for Msg1 transmitted by the UE is present may be determined by determining whether a random access preamble ID for the preamble transmitted by the UE is present. If a response for Msg1 is not present, the UE may retransmit an RACH preamble within a given number, while performing power ramping. The UE calculates PRACH transmission power for the retransmission of the preamble based on the most recent pathloss and a power ramping counter.

The UE may transmit UL transmission as Msg3 of the random access process on an uplink shared channel based on random access response information. Msg3 may include an RRC connection request and a UE identity. As a response to the Msg3, a network may transmit Msg4, which may be treated as a contention resolution message on the DL. The UE may enter an RRC connected state by receiving the Msg4.

Beam Management (BM) Procedure of 5G Communication System

A BM process may be divided into (1) a DL BM process using an SSB or CSI-RS and (2) an UL BM process using a sounding reference signal (SRS). Furthermore, each BM process may include Tx beam sweeping configured to determine a Tx beam and Rx beam sweeping configured to determine an Rx beam.

A DL BM process using an SSB is described.

The configuration of beam reporting using an SSB is performed when a channel state information (CSI)/beam configuration is performed in RRC_CONNECTED.

A UE receives, from a BS, a CSI-ResourceConfig IE including CSI-SSB-ResourceSetList for SSB resources used for BM. RRC parameter csi-SSB-ResourceSetList indicates a list of SSB resources used for beam management and reporting in one resource set. In this case, the SSB resource set may be configured with {SSBx1, SSBx2, SSBx3, SSBx4, . . . }. SSB indices may be defined from 0 to 63.

The UE receives signals on the SSB resources from the BS based on the CSI-SSB-ResourceSetList.

If SSBRI and CSI-RS reportConfig related to the reporting of reference signal received power (RSRP) have been configured, the UE reports the best SSBRI and corresponding RSRP to the BS. For example, if reportQuantity of the CSI-RS reportConfig IE is configured as “ssb-Index-RSRP”, the UE reports the best SSBRI and corresponding RSRP to the BS.

If a CSI-RS resource is configured in an OFDM symbol(s) identical with an SSB and “QCL-TypeD” is applicable, the UE may assume that the CSI-RS and the SSB have been quasi co-located (QCL) in the viewpoint of “QCL-TypeD.” In this case, QCL-TypeD may mean that antenna ports have been QCLed in the viewpoint of a spatial Rx parameter. The UE may apply the same reception beam when it receives the signals of a plurality of DL antenna ports having a QCL-TypeD relation.

Next, a DL BM process using a CSI-RS is described.

An Rx beam determination (or refinement) process of a UE and a Tx beam sweeping process of a BS using a CSI-RS are sequentially described. In the Rx beam determination process of the UE, a parameter is repeatedly set as “ON.” In the Tx beam sweeping process of the BS, a parameter is repeatedly set as “OFF.”

First, the Rx beam determination process of a UE is described.

The UE receives an NZP CSI-RS resource set IE, including an RRC parameter regarding “repetition”, from a BS through RRC signaling. In this case, the RRC parameter “repetition” has been set as “ON.”

The UE repeatedly receives signals on a resource(s) within a CSI-RS resource set in which the RRC parameter “repetition” has been set as “ON” in different OFDM symbols through the same Tx beam (or DL spatial domain transmission filter) of the BS.

The UE determines its own Rx beam.

The UE omits CSI reporting. That is, if the RRC parameter “repetition” has been set as “ON”, the UE may omit CSI reporting.

Next, the Tx beam determination process of a BS is described.

A UE receives an NZP CSI-RS resource set IE, including an RRC parameter regarding “repetition”, from the BS through RRC signaling. In this case, the RRC parameter “repetition” has been set as “OFF”, and is related to the Tx beam sweeping process of the BS.

The UE receives signals on resources within a CSI-RS resource set in which the RRC parameter “repetition” has been set as “OFF” through different Tx beams (DL spatial domain transmission filter) of the BS.

The UE selects (or determines) the best beam.

The UE reports, to the BS, the ID (e.g., CRI) of the selected beam and related quality information (e.g., RSRP). That is, the UE reports, to the BS, a CRI and corresponding RSRP, if a CSI-RS is transmitted for BM.

Next, an UL BM process using an SRS is described.

A UE receives, from a BS, RRC signaling (e.g., SRS-Config IE) including a use parameter configured (RRC parameter) as “beam management.” The SRS-Config IE is used for an SRS transmission configuration. The SRS-Config IE includes a list of SRS-Resources and a list of SRS-ResourceSets. Each SRS resource set means a set of SRS-resources.

The UE determines Tx beamforming for an SRS resource to be transmitted based on SRS-SpatialRelation Info included in the SRS-Config IE. In this case, SRS-SpatialRelation Info is configured for each SRS resource, and indicates whether to apply the same beamforming as beamforming used in an SSB, CSI-RS or SRS for each SRS resource.

If SRS-SpatialRelationInfo is configured in the SRS resource, the same beamforming as beamforming used in the SSB, CSI-RS or SRS is applied, and transmission is performed. However, if SRS-SpatialRelationInfo is not configured in the SRS resource, the UE randomly determines Tx beamforming and transmits an SRS through the determined Tx beamforming.

Next, a beam failure recovery (BFR) process is described.

In a beamformed system, a radio link failure (RLF) frequently occurs due to the rotation, movement or beamforming blockage of a UE. Accordingly, in order to prevent an RLF from occurring frequently, BFR is supported in NR. BFR is similar to a radio link failure recovery process, and may be supported when a UE is aware of a new candidate beam(s). For beam failure detection, a BS configures beam failure detection reference signals in a UE. If the number of beam failure indications from the physical layer of the UE reaches a threshold set by RRC signaling within a period configured by the RRC signaling of the BS, the UE declares a beam failure. After a beam failure is detected, the UE triggers beam failure recovery by initiating a random access process on a PCell, selects a suitable beam, and performs beam failure recovery (if the BS has provided dedicated random access resources for certain beams, they are prioritized by the UE). When the random access procedure is completed, the beam failure recovery is considered to be completed.

Ultra-Reliable and Low Latency Communication (URLLC)

URLLC transmission defined in NR may mean transmission for (1) a relatively low traffic size, (2) a relatively low arrival rate, (3) extremely low latency requirement (e.g., 0.5, 1 ms), (4) relatively short transmission duration (e.g., 2 OFDM symbols), and (5) an urgent service/message. In the case of the UL, in order to satisfy more stringent latency requirements, transmission for a specific type of traffic (e.g., URLLC) needs to be multiplexed with another transmission (e.g., eMBB) that has been previously scheduled. As one scheme related to this, information indicating that a specific resource will be preempted is provided to a previously scheduled UE, and the URLLC UE uses the corresponding resource for UL transmission.

In the case of NR, dynamic resource sharing between eMBB and URLLC is supported. EMBB and URLLC services may be scheduled on non-overlapping time/frequency resources. URLLC transmission may occur in resources scheduled for ongoing eMBB traffic. An eMBB UE may not be aware of whether the PDSCH transmission of a corresponding UE has been partially punctured. The UE may not decode the PDSCH due to corrupted coded bits. NR provides a preemption indication by taking this into consideration. The preemption indication may also be denoted as an interrupted transmission indication.

In relation to a preemption indication, a UE receives a DownlinkPreemption IE through RRC signaling from a BS. When the UE is provided with the DownlinkPreemption IE, the UE is configured with an INT-RNTI provided by a parameter int-RNTI within a DownlinkPreemption IE for the monitoring of a PDCCH that conveys DCI format 2_1. The UE is configured with a set of serving cells by INT-ConfigurationPerServing Cell, including a set of serving cell indices additionally provided by servingCellID, and a corresponding set of locations for fields within DCI format 2_1 by locationInDCI, configured with an information payload size for DCI format 2_1 by dci-PayloadSize, and configured with the indication granularity of time-frequency resources by timeFrequencySect.

The UE receives DCI format 2_1 from the BS based on the DownlinkPreemption IE.

When the UE detects DCI format 2_1 for a serving cell within a configured set of serving cells, the UE may assume that there is no transmission to the UE within PRBs and symbols indicated by the DCI format 2_1, among a set of the (last) monitoring period of a monitoring period and a set of symbols to which the DCI format 2_1 belongs. For example, the UE assumes that a signal within a time-frequency resource indicated by preemption is not DL transmission scheduled therefor, and decodes data based on signals reported in the remaining resource region.

Massive MTC (mMTC)

Massive machine type communication (mMTC) is one of 5G scenarios for supporting super connection service for simultaneous communication with many UEs. In this environment, a UE intermittently performs communication at a very low transmission speed and mobility. Accordingly, mMTC has a major object regarding how long will be a UE driven how low the cost is. In relation to the mMTC technology, in 3GPP, MTC and NarrowBand (NB)-IoT are handled.

The mMTC technology has characteristics, such as repetition transmission, frequency hopping, retuning, and a guard period for a PDCCH, a PUCCH, a physical downlink shared channel (PDSCH), and a PUSCH.

That is, a PUSCH (or PUCCH (in particular, long PUCCH) or PRACH) including specific information and a PDSCH (or PDCCH) including a response for specific information are repeatedly transmitted. The repetition transmission is performed through frequency hopping. For the repetition transmission, (RF) retuning is performed in a guard period from a first frequency resource to a second frequency resource. Specific information and a response for the specific information may be transmitted/received through a narrowband (e.g., 6 RB (resource block) or 1 RB).

Robot Basic Operation Using 5G Communication

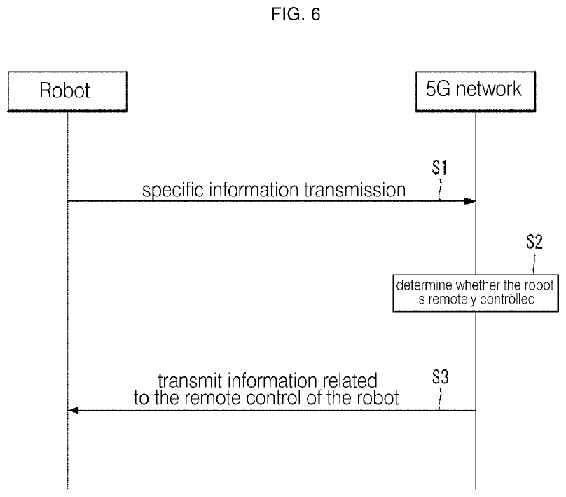

FIG. 6 shows an example of a basic operation of a robot and a 5G network in a 5G communication system.

A robot transmits specific information transmission to a 5G network (S1). Furthermore, the 5G network may determine whether the robot is remotely controlled (S2). In this case, the 5G network may include a server or module for performing robot-related remote control.

Furthermore, the 5G network may transmit, to the robot, information (or signal) related to the remote control of the robot (S3).

Application Operation Between Robot and 5G Network in 5G Communication System

Hereafter, a robot operation using 5G communication is described more specifically with reference to FIGS. 1 to 6 and the above-described wireless communication technology (BM procedure, URLLC, mMTC).

First, a basic procedure of a method to be proposed later in the present invention and an application operation to which the eMBB technology of 5G communication is applied is described.

As in steps S1 and S3 of FIG. 3, in order for a robot to transmit/receive a signal, information, etc. to/from a 5G network, the robot performs an initial access procedure and a random access procedure along with a 5G network prior to step S1 of FIG. 3.

More specifically, in order to obtain DL synchronization and system information, the robot performs an initial access procedure along with the 5G network based on an SSB. In the initial access procedure, a beam management (BM) process and a beam failure recovery process may be added. In a process for the robot to receive a signal from the 5G network, a quasi-co location (QCL) relation may be added.

Furthermore, the robot performs a random access procedure along with the 5G network for UL synchronization acquisition and/or UL transmission. Furthermore, the 5G network may transmit an UL grant for scheduling the transmission of specific information to the robot. Accordingly, the robot transmits specific information to the 5G network based on the UL grant. Furthermore, the 5G network transmits, to the robot, a DL grant for scheduling the transmission of a 5G processing result for the specific information. Accordingly, the 5G network may transmit, to the robot, information (or signal) related to remote control based on the DL grant.

A basic procedure of a method to be proposed later in the present invention and an application operation to which the URLLC technology of 5G communication is applied is described below.

As described above, after a robot performs an initial access procedure and/or a random access procedure along with a 5G network, the robot may receive a DownlinkPreemption IE from the 5G network. Furthermore, the robot receives, from the 5G network, DCI format 2_1 including pre-emption indication based on the DownlinkPreemption IE. Furthermore, the robot does not perform (or expect or assume) the reception of eMBB data in a resource (PRB and/or OFDM symbol) indicated by the pre-emption indication. Thereafter, if the robot needs to transmit specific information, it may receive an UL grant from the 5G network.

A basic procedure of a method to be proposed later in the present invention and an application operation to which the mMTC technology of 5G communication is applied is described below.

A portion made different due to the application of the mMTC technology among the steps of FIG. 6 is chiefly described.

In step S1 of FIG. 6, the robot receives an UL grant from the 5G network in order to transmit specific information to the 5G network. In this case, the UL grant includes information on the repetition number of transmission of the specific information. The specific information may be repeatedly transmitted based on the information on the repetition number. That is, the robot transmits specific information to the 5G network based on the UL grant. Furthermore, the repetition transmission of the specific information may be performed through frequency hopping. The transmission of first specific information may be performed in a first frequency resource, and the transmission of second specific information may be performed in a second frequency resource. The specific information may be transmitted through the narrowband of 6 resource blocks (RBs) or 1 RB.

Operation Between Robots Using 5G Communication

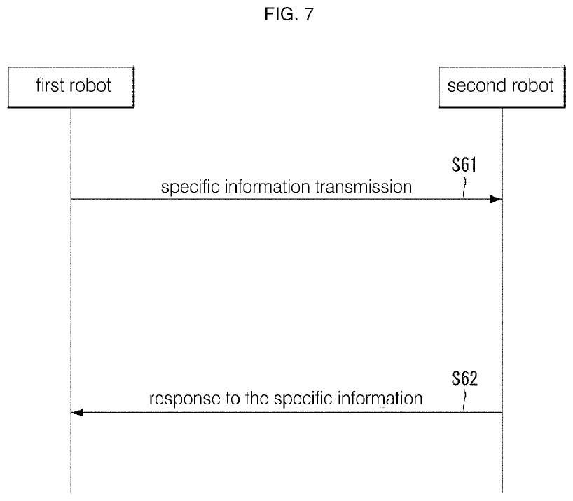

FIG. 7 illustrates an example of a basic operation between robots using 5G communication.

A first robot transmits specific information to a second robot (S61). The second robot transmits, to the first robot, a response to the specific information (S62).

Meanwhile, the configuration of an application operation between robots may be different depending on whether a 5G network is involved directly (sidelink communication transmission mode 3) or indirectly (sidelink communication transmission mode 4) in the specific information, the resource allocation of a response to the specific information.

An application operation between robots using 5G communication is described below.

First, a method for a 5G network to be directly involved in the resource allocation of signal transmission/reception between robots is described.

The 5G network may transmit a DCI format 5A to a first robot for the scheduling of mode 3 transmission (PSCCH and/or PSSCH transmission). In this case, the physical sidelink control channel (PSCCH) is a 5G physical channel for the scheduling of specific information transmission, and the physical sidelink shared channel (PSSCH) is a 5G physical channel for transmitting the specific information. Furthermore, the first robot transmits, to a second robot, an SCI format 1 for the scheduling of specific information transmission on a PSCCH. Furthermore, the first robot transmits specific information to the second robot on the PSSCH.

A method for a 5G network to be indirectly involved in the resource allocation of signal transmission/reception is described below.

A first robot senses a resource for mode 4 transmission in a first window. Furthermore, the first robot selects a resource for mode 4 transmission in a second window based on a result of the sensing. In this case, the first window means a sensing window, and the second window means a selection window. The first robot transmits, to the second robot, an SCI format 1 for the scheduling of specific information transmission on a PSCCH based on the selected resource. Furthermore, the first robot transmits specific information to the second robot on a PSSCH.

The above-described structural characteristic of the drone, the 5G communication technology, etc. may be combined with methods to be described, proposed in the present inventions, and may be applied or may be supplemented to materialize or clarify the technical characteristics of methods proposed in the present inventions.

Drone

Unmanned Aerial System: A Combination of a UAV and a UAV Controller

Unmanned aerial vehicle: an aircraft that is remotely piloted without a human pilot, and it may be represented as an unmanned aerial robot, a drone, or simply a robot.

UAV controller: device used to control a UAV remotely

ATC: Air Traffic Control

NLOS: Non-line-of-sight

UAS: Unmanned Aerial System

UAV: Unmanned Aerial Vehicle

UCAS: Unmanned Aerial Vehicle Collision Avoidance System

UTM: Unmanned Aerial Vehicle Traffic Management

C2: Command and Control

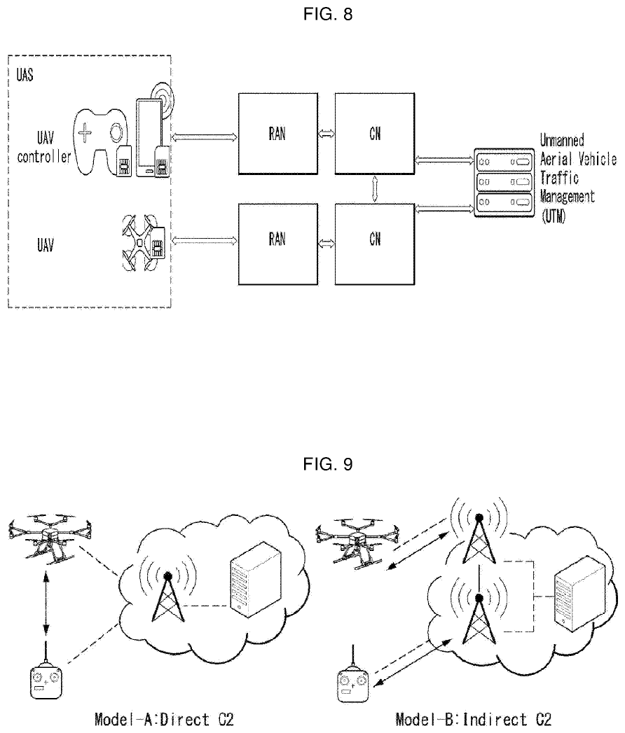

FIG. 8 is a diagram showing an example of the concept diagram of a 3GPP system including a UAS.

An unmanned aerial system (UAS) is a combination of an unmanned aerial vehicle (UAV), sometimes called a drone, and a UAV controller. The UAV is an aircraft not including a human pilot device. Instead, the UAV is controlled by a terrestrial operator through a UAV controller, and may have autonomous flight capabilities. A communication system between the UAV and the UAV controller is provided by the 3GPP system. In terms of the size and weight, the range of the UAV is various from a small and light aircraft that is frequently used for recreation purposes to a large and heavy aircraft that may be more suitable for commercial purposes. Regulation requirements are different depending on the range and are different depending on the area.

Communication requirements for a UAS include data uplink and downlink to/from a UAS component for both a serving 3GPP network and a network server, in addition to a command and control (C2) between a UAV and a UAV controller. Unmanned aerial system traffic management (UTM) is used to provide UAS identification, tracking, authorization, enhancement and the regulation of UAS operations and to store data necessary for a UAS for an operation. Furthermore, the UTM enables a certified user (e.g., air traffic control, public safety agency) to query an identity (ID), the meta data of a UAV, and the controller of the UAV.

The 3GPP system enables UTM to connect a UAV and a UAV controller so that the UAV and the UAV controller are identified as a UAS. The 3GPP system enables the UAS to transmit, to the UTM, UAV data that may include the following control information.

Control information: a unique identity (this may be a 3GPP identity), UE capability, manufacturer and model, serial number, take-off weight, location, owner identity, owner address, owner contact point detailed information, owner certification, take-off location, mission type, route data, an operating status of a UAV.

The 3GPP system enables a UAS to transmit UAV controller data to UTM. Furthermore, the UAV controller data may include a unique ID (this may be a 3GPP ID), the UE function, location, owner ID, owner address, owner contact point detailed information, owner certification, UAV operator identity confirmation, UAV operator license, UAV operator certification, UAV pilot identity, UAV pilot license, UAV pilot certification and flight plan of a UAV controller.

The functions of a 3GPP system related to a UAS may be summarized as follows.

A 3GPP system enables the UAS to transmit different UAS data to UTM based on different certification and an authority level applied to the UAS.

A 3GPP system supports a function of expanding UAS data transmitted to UTM along with future UTM and the evolution of a support application.

A 3GPP system enables the UAS to transmit an identifier, such as international mobile equipment identity (IMEI), a mobile station international subscriber directory number (MSISDN) or an international mobile subscriber identity (IMSI) or IP address, to UTM based on regulations and security protection.

A 3GPP system enables the UE of a UAS to transmit an identity, such as an IMEI, MSISDN or IMSI or IP address, to UTM.

A 3GPP system enables a mobile network operator (MNO) to supplement data transmitted to UTM, along with network-based location information of a UAV and a UAV controller.

A 3GPP system enables MNO to be notified of a result of permission so that UTM operates.

A 3GPP system enables MNO to permit a UAS certification request only when proper subscription information is present.

A 3GPP system provides the ID(s) of a UAS to UTM.

A 3GPP system enables a UAS to update UTM with live location information of a UAV and a UAV controller.

A 3GPP system provides UTM with supplement location information of a UAV and a UAV controller.

A 3GPP system supports UAVs, and corresponding UAV controllers are connected to other PLMNs at the same time.

A 3GPP system provides a function for enabling the corresponding system to obtain UAS information on the support of a 3GPP communication capability designed for a UAS operation.

A 3GPP system supports UAS identification and subscription data capable of distinguishing between a UAS having a UAS capable UE and a USA having a non-UAS capable UE.

A 3GPP system supports detection, identification, and the reporting of a problematic UAV(s) and UAV controller to UTM.

In the service requirement of Rel-16 ID_UAS, the UAS is driven by a human operator using a UAV controller in order to control paired UAVs. Both the UAVs and the UAV controller are connected using two individual connections over a 3GPP network for a command and control (C2) communication. The first contents to be taken into consideration with respect to a UAS operation include a mid-air collision danger with another UAV, a UAV control failure danger, an intended UAV misuse danger and various dangers of a user (e.g., business in which the air is shared, leisure activities). Accordingly, in order to avoid a danger in safety, if a 5G network is considered as a transmission network, it is important to provide a UAS service by QoS guarantee for C2 communication.

FIG. 9 shows examples of a C2 communication model for a UAV.

Model-A is direct C2. A UAV controller and a UAV directly configure a C2 link (or C2 communication) in order to communicate with each other, and are registered with a 5G network using a wireless resource that is provided, configured and scheduled by the 5G network, for direct C2 communication. Model-B is indirect C2. A UAV controller and a UAV establish and register respective unicast C2 communication links for a 5G network, and communicate with each other over the 5G network. Furthermore, the UAV controller and the UAV may be registered with the 5G network through different NG-RAN nodes. The 5G network supports a mechanism for processing the stable routing of C2 communication in any cases. A command and control use C2 communication for forwarding from the UAV controller/UTM to the UAV. C2 communication of this type (model-B) includes two different lower classes for incorporating a different distance between the UAV and the UAV controller/UTM, including a line of sight (VLOS) and a non-line of sight (non-VLOS). Latency of this VLOS traffic type needs to take into consideration a command delivery time, a human response time, and an assistant medium, for example, video streaming, the indication of a transmission waiting time. Accordingly, sustainable latency of the VLOS is shorter than that of the Non-VLOS. A 5G network configures each session for a UAV and a UAV controller. This session communicates with UTM, and may be used for default C2 communication with a UAS.

As part of a registration procedure or service request procedure, a UAV and a UAV controller request a UAS operation from UTM, and provide a pre-defined service class or requested UAS service (e.g., navigational assistance service, weather), identified by an application ID(s), to the UTM. The UTM permits the UAS operation for the UAV and the UAV controller, provides an assigned UAS service, and allocates a temporary UAS-ID to the UAS. The UTM provides a 5G network with information necessary for the C2 communication of the UAS. For example, the information may include a service class, the traffic type of UAS service, requested QoS of the permitted UAS service, and the subscription of the UAS service. When a request to establish C2 communication with the 5G network is made, the UAV and the UAV controller indicate a preferred C2 communication model (e.g., model-B) along with the UAS-ID allocated to the 5G network. If an additional C2 communication connection is to be generated or the configuration of the existing data connection for C2 needs to be changed, the 5G network modifies or allocates one or more QoS flows for C2 communication traffic based on requested QoS and priority in the approved UAS service information and C2 communication of the UAS.

UAV Traffic Management

(1) Centralized UAV Traffic Management

A 3GPP system provides a mechanism that enables UTM to provide a UAV with route data along with flight permission. The 3GPP system forwards, to a UAS, route modification information received from the UTM with latency of less than 500 ms. The 3GPP system needs to forward notification, received from the UTM, to a UAV controller having a waiting time of less than 500 ms.

(2) De-Centralized UAV Traffic Management

A 3GPP system broadcasts the following data (e.g., if it is requested based on another regulation requirement, UAV identities, UAV type, a current location and time, flight route information, current velocity, operation state) so that a UAV identifies a UAV(s) in a short-distance area for collision avoidance.

A 3GPP system supports a UAV in order to transmit a message through a network connection for identification between different UAVs. The UAV preserves owner's personal information of a UAV, UAV pilot and UAV operator in the broadcasting of identity information.

A 3GPP system enables a UAV to receive local broadcasting communication transmission service from another UAV in a short distance.

A UAV may use direct UAV versus UAV local broadcast communication transmission service in or out of coverage of a 3GPP network, and may use the direct UAV versus UAV local broadcast communication transmission service if transmission/reception UAVs are served by the same or different PLMNs.

A 3GPP system supports the direct UAV versus UAV local broadcast communication transmission service at a relative velocity of a maximum of 320 kmph. The 3GPP system supports the direct UAV versus UAV local broadcast communication transmission service having various types of message payload of 50-1500 bytes other than security-related message elements.

A 3GPP system supports the direct UAV versus UAV local broadcast communication transmission service capable of guaranteeing separation between UAVs. In this case, the UAVs may be considered to have been separated if they are in a horizontal distance of at least 50 m or a vertical distance of 30 m or both. The 3GPP system supports the direct UAV versus UAV local broadcast communication transmission service that supports the range of a maximum of 600 m.

A 3GPP system supports the direct UAV versus UAV local broadcast communication transmission service capable of transmitting a message with frequency of at least 10 message per second, and supports the direct UAV versus UAV local broadcast communication transmission service capable of transmitting a message whose inter-terminal waiting time is a maximum of 100 ms.

A UAV may broadcast its own identity locally at least once per second, and may locally broadcast its own identity up to a 500 m range.

Security

A 3GPP system protects data transmission between a UAS and UTM. The 3GPP system provides protection against the spoofing attack of a UAS ID. The 3GPP system permits the non-repudiation of data, transmitted between the UAS and the UTM, in the application layer. The 3GPP system supports the integrity of a different level and the capability capable of providing a personal information protection function with respect to a different connection between the UAS and the UTM, in addition to data transmitted through a UAS and UTM connection. The 3GPP system supports the classified protection of an identity and personal identification information related to the UAS. The 3GPP system supports regulation requirements (e.g., lawful intercept) for UAS traffic.

When a UAS requests the authority capable of accessing UAS data service from an MNO, the MNO performs secondary check (after initial mutual certification or simultaneously with it) in order to establish UAS qualification verification to operate. The MNO is responsible for transmitting and potentially adding additional data to the request so that the UAS operates as unmanned aerial system traffic management (UTM). In this case, the UTM is a 3GPP entity. The UTM is responsible for the approval of the UAS that operates and identifies the qualification verification of the UAS and the UAV operator. One option is that the UTM is managed by an aerial traffic control center. The aerial traffic control center stores all data related to the UAV, the UAV controller, and live location. When the UAS fails in any part of the check, the MNO may reject service for the UAS and thus may reject operation permission.

3GPP Support for Aerial UE (or Drone) Communication

An E-UTRAN-based mechanism that provides an LTE connection to a UE capable of aerial communication is supported through the following functions.

Subscription-based aerial UE identification and authorization defined in Section TS 23.401, 4.3.31.

Height reporting based on an event in which the altitude of a UE exceeds a reference altitude threshold configured with a network.

Interference detection based on measurement reporting triggered when the number of configured cells (i.e., greater than 1) satisfies a triggering criterion at the same time.

Signaling of flight route information from a UE to an E-UTRAN.

Location information reporting including the horizontal and vertical velocity of a UE.

(1) Subscription-Based Identification of Aerial UE Function

The support of the aerial UE function is stored in user subscription information of an HSS. The HSS transmits the information to an MME in an Attach, Service Request and Tracking Area Update process. The subscription information may be provided from the MME to a base station through an S1 AP initial context setup request during the Attach, tracking area update and service request procedure. Furthermore, in the case of X2-based handover, a source base station (BS) may include subscription information in an X2-AP Handover Request message toward a target BS. More detailed contents are described later. With respect to intra and inter MME S1-based handover, the MME provides subscription information to the target BS after the handover procedure.

(2) Height-Based Reporting for Aerial UE Communication

An aerial UE may be configured with event-based height reporting. The aerial UE transmits height reporting when the altitude of the UE is higher or lower than a set threshold. The reporting includes height and a location.

(3) Interference Detection and Mitigation for Aerial UE Communication

For interference detection, when each (per cell) RSRP value for the number of configured cells satisfies a configured event, an aerial UE may be configured with an RRM event A3, A4 or A5 that triggers measurement reporting. The reporting includes an RRM result and location. For interference mitigation, the aerial UE may be configured with a dedicated UE-specific alpha parameter for PUSCH power control.

(4) Flight Route Information Reporting

An E-UTRAN may request a UE to report flight route information configured with a plurality of middle points defined as 3D locations, as defined in TS 36.355. If the flight route information is available for the UE, the UE reports a waypoint for a configured number. The reporting may also include a time stamp per waypoint if it is configured in the request and available for the UE.

(5) Location Reporting for Aerial UE Communication

Location information for aerial UE communication may include a horizontal and vertical velocity if they have been configured. The location information may be included in the RRM reporting and the height reporting.

Hereafter, (1) to (5) of 3GPP support for aerial UE communication is described more specifically.

DL/UL Interference Detection

For DL interference detection, measurements reported by a UE may be useful. UL interference detection may be performed based on measurement in a base station or may be estimated based on measurements reported by a UE. Interference detection can be performed more effectively by improving the existing measurement reporting mechanism. Furthermore, for example, other UE-based information, such as mobility history reporting, speed estimation, a timing advance adjustment value, and location information, may be used by a network in order to help interference detection. More detailed contents of measurement execution are described later.

DL Interference Mitigation

In order to mitigate DL interference in an aerial UE, LTE Release-13 FD-MIMO may be used. Although the density of aerial UEs is high, Rel-13 FD-MIMO may be advantageous in restricting an influence on the DL terrestrial UE throughput, while providing a DL aerial UE throughput that satisfies DL aerial UE throughput requirements. In order to mitigate DL interference in an aerial UE, a directional antenna may be used in the aerial UE. In the case of a high-density aerial UE, a directional antenna in the aerial UE may be advantageous in restricting an influence on a DL terrestrial UE throughput. The DL aerial UE throughput has been improved compared to a case where a non-directional antenna is used in the aerial UE. That is, the directional antenna is used to mitigate interference in the downlink for aerial UEs by reducing interference power from wide angles. In the viewpoint that a LOS direction between an aerial UE and a serving cell is tracked, the following types of capability are taken into consideration:

1) Direction of Travel (DoT): an aerial UE does not recognize the direction of a serving cell LOS, and the antenna direction of the aerial UE is aligned with the DoT.

2) Ideal LOS: an aerial UE perfectly tracks the direction of a serving cell LOS and pilots the line of sight of an antenna toward a serving cell.

3) Non-ideal LOS: an aerial UE tracks the direction of a serving cell LOS, but has an error due to actual restriction.

In order to mitigate DL interference with aerial UEs, beamforming in aerial UEs may be used. Although the density of aerial UEs is high, beamforming in the aerial UEs may be advantageous in restricting an influence on a DL terrestrial UE throughput and improving a DL aerial UE throughput. In order to mitigate DL interference in an aerial UE, intra-site coherent JT CoMP may be used. Although the density of aerial UEs is high, the intra-site coherent JT can improve the throughput of all UEs. An LTE Release-13 coverage extension technology for non-bandwidth restriction devices may also be used. In order to mitigate DL interference in an aerial UE, a coordinated data and control transmission method may be used. An advantage of the coordinated data and control transmission method is to increase an aerial UE throughput, while restricting an influence on a terrestrial UE throughput. It may include signaling for indicating a dedicated DL resource, an option for cell muting/ABS, a procedure update for cell (re)selection, acquisition for being applied to a coordinated cell, and the cell ID of a coordinated cell.

UL Interference Mitigation

In order to mitigate UL interference caused by aerial UEs, an enhanced power control mechanisms may be used. Although the density of aerial UEs is high, the enhanced power control mechanism may be advantageous in restricting an influence on a UL terrestrial UE throughput.

The above power control-based mechanism influences the following contents.

UE-specific partial pathloss compensation factor

UE-specific Po parameter

Neighbor cell interference control parameter

Closed-loop power control

The power control-based mechanism for UL interference mitigation is described more specifically.

1) UE-Specific Partial Pathloss Compensation Factor

The enhancement of the existing open-loop power control mechanism is taken into consideration in the place where a UE-specific partial pathloss compensation factor αUE is introduced. Due to the introduction of the UE-specific partial pathloss compensation factor αUE, different αUE may be configured by comparing an aerial UE with a partial pathloss compensation factor configured in a terrestrial UE.

2) UE-Specific PO Parameter

Aerial UEs are configured with different Po compared with Po configured for terrestrial UEs. The enhance of the existing power control mechanism is not necessary because the UE-specific Po is already supported in the existing open-loop power control mechanism.

Furthermore, the UE-specific partial pathloss compensation factor αUE and the UE-specific Po may be used in common for uplink interference mitigation. Accordingly, the UE-specific partial pathloss compensation factor αUE and the UE-specific Po can improve the uplink throughput of a terrestrial UE, while scarifying the reduced uplink throughput of an aerial UE.

3) Closed-Loop Power Control

Target reception power for an aerial UE is coordinated by taking into consideration serving and neighbor cell measurement reporting. Closed-loop power control for aerial UEs needs to handle a potential high-speed signal change in the sky because aerial UEs may be supported by the sidelobes of base station antennas.

In order to mitigate UL interference attributable to an aerial UE, LTE Release-13 FD-MIMO may be used. In order to mitigate UL interference caused by an aerial UE, a UE-directional antenna may be used. In the case of a high-density aerial UE, a UE-directional antenna may be advantageous in restricting an influence on an UL terrestrial UE throughput. That is, the directional UE antenna is used to reduce uplink interference generated by an aerial UE by reducing a wide angle range of uplink signal power from the aerial UE. The following type of capability is taken into consideration in the viewpoint in which an LOS direction between an aerial UE and a serving cell is tracked:

1) Direction of Travel (DoT): an aerial UE does not recognize the direction of a serving cell LOS, and the antenna direction of the aerial UE is aligned with the DoT.

2) Ideal LOS: an aerial UE perfectly tracks the direction of a serving cell LOS and pilots the line of sight of the antenna toward a serving cell.

3) Non-ideal LOS: an aerial UE tracks the direction of a serving cell LOS, but has an error due to actual restriction.

A UE may align an antenna direction with an LOS direction and amplify power of a useful signal depending on the capability of tracking the direction of an LOS between the aerial UE and a serving cell. Furthermore, UL transmission beamforming may also be used to mitigate UL interference.

Mobility

Mobility performance (e.g., a handover failure, a radio link failure (RLF), handover stop, a time in Qout) of an aerial UE is weakened compared to a terrestrial UE. It is expected that the above-described DL and UL interference mitigation technologies may improve mobility performance for an aerial UE. Better mobility performance in a rural area network than in an urban area network is monitored. Furthermore, the existing handover procedure may be improved to improve mobility performance.

Improvement of a handover procedure for an aerial UE and/or mobility of a handover-related parameter based on location information and information, such as the aerial state of a UE and a flight route plan

A measurement reporting mechanism may be improved in such a way as to define a new event, enhance a trigger condition, and control the quantity of measurement reporting.

The existing mobility enhancement mechanism (e.g., mobility history reporting, mobility state estimation, UE support information) operates for an aerial UE and may be first evaluated if additional improvement is necessary. A parameter related to a handover procedure for an aerial UE may be improved based on aerial state and location information of the UE. The existing measurement reporting mechanism may be improved by defining a new event, enhancing a triggering condition, and controlling the quantity of measurement reporting. Flight route plan information may be used for mobility enhancement.

A measurement execution method which may be applied to an aerial UE is described more specifically.

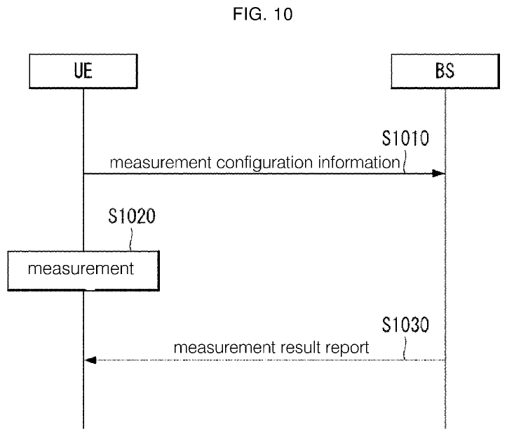

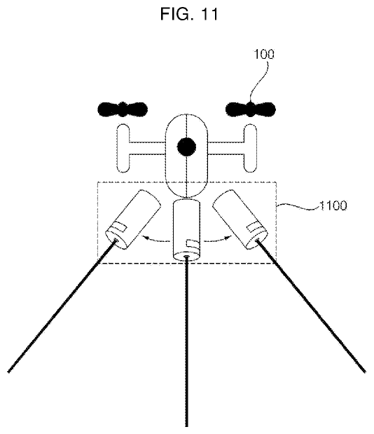

FIG. 10 is a flowchart showing an example of a measurement execution method to which the present invention is applicable.

An aerial UE receives measurement configuration information from a base station (S1010). In this case, a message including the measurement configuration information is called a measurement configuration message. The aerial UE performs measurement based on the measurement configuration information (S1020). If a measurement result satisfies a reporting condition within the measurement configuration information, the aerial UE reports the measurement result to the base station (S1030). A message including the measurement result is called a measurement report message. The measurement configuration information may include the following information.

(1) Measurement object information: this is information on an object on which an aerial UE will perform measurement. The measurement object includes at least one of an intra-frequency measurement object that is an object of measurement within a cell, an inter-frequency measurement object that is an object of inter-cell measurement, or an inter-RAT measurement object that is an object of inter-RAT measurement. For example, the intra-frequency measurement object may indicate a neighbor cell having the same frequency band as a serving cell. The inter-frequency measurement object may indicate a neighbor cell having a frequency band different from that of a serving cell. The inter-RAT measurement object may indicate a neighbor cell of an RAT different from the RAT of a serving cell.

(2) Reporting configuration information: this is information on a reporting condition and reporting type regarding when an aerial UE reports the transmission of a measurement result. The reporting configuration information may be configured with a list of reporting configurations. Each reporting configuration may include a reporting criterion and a reporting format. The reporting criterion is a level in which the transmission of a measurement result by a UE is triggered. The reporting criterion may be the periodicity of measurement reporting or a single event for measurement reporting. The reporting format is information regarding that an aerial UE will configure a measurement result in which type.

An event related to an aerial UE includes (i) an event H1 and (ii) an event H2.

Event H1 (Aerial UE Height Exceeding a Threshold)

A UE considers that an entering condition for the event is satisfied when 1) the following defined condition H1-1 is satisfied, and considers that a leaving condition for the event is satisfied when 2) the following defined condition H1-2 is satisfied.

Inequality H1-1 (entering condition):

Ms−Hys>Thresh+Offset

Inequality H1-2 (leaving condition):

Ms+Hys<Thresh+Offset

In the above equation, the variables are defined as follows.

Ms is an aerial UE height and does not take any offset into consideration. Hys is a hysteresis parameter (i.e., h1-hysteresis as defined in ReportConfigEUTRA) for an event. Thresh is a reference threshold parameter variable for the event designated in MeasConfig (i.e., heightThreshRef defined within MeasConfig). Offset is an offset value for heightThreshRef for obtaining an absolute threshold for the event (i.e., h1-ThresholdOffset defined in ReportConfigEUTRA). Ms is indicated in meters. Thresh is represented in the same unit as Ms.

Event H2 (Aerial UE Height of Less than Threshold)

A UE considers that an entering condition for an event is satisfied 1) the following defined condition H2-1 is satisfied, and considers that a leaving condition for the event is satisfied 2) when the following defined condition H2-2 is satisfied.

Inequality H2-1 (entering condition):

Ms+Hys<Thresh+Offset

Inequality H2-2 (leaving condition):

Ms−Hys>Thresh+Offset

In the above equation, the variables are defined as follows.

Ms is an aerial UE height and does not take any offset into consideration. Hys is a hysteresis parameter (i.e., h1-hysteresis as defined in ReportConfigEUTRA) for an event. Thresh is a reference threshold parameter variable for the event designated in MeasConfig (i.e., heightThreshRef defined within MeasConfig). Offset is an offset value for heightThreshRef for obtaining an absolute threshold for the event (i.e., h2-ThresholdOffset defined in ReportConfigEUTRA). Ms is indicated in meters. Thresh is represented in the same unit as Ms.

(3) Measurement identity information: this is information on a measurement identity by which an aerial UE determines to report which measurement object using which type by associating the measurement object and a reporting configuration. The measurement identity information is included in a measurement report message, and may indicate that a measurement result is related to which measurement object and that measurement reporting has occurred according to which reporting condition.

(4) Quantity configuration information: this is information on a parameter for configuring filtering of a measurement unit, a reporting unit and/or a measurement result value.

(5) Measurement gap information: this is information on a measurement gap, that is, an interval which may be used by an aerial UE in order to perform only measurement without taking into consideration data transmission with a serving cell because downlink transmission or uplink transmission has not been scheduled in the aerial UE.

In order to perform a measurement procedure, an aerial UE has a measurement object list, a measurement reporting configuration list, and a measurement identity list. If a measurement result of the aerial UE satisfies a configured event, the UE transmits a measurement report message to a base station.

In this case, the following parameters may be included in a UE-EUTRA-Capability Information Element in relation to the measurement reporting of the aerial UE. IE UE-EUTRA-Capability is used to forward, to a network, an E-RA UE Radio Access Capability parameter and a function group indicator for an essential function. IE UE-EUTRA-Capability is transmitted in an E-UTRA or another RAT. Table 1 is a table showing an example of the UE-EUTRA-Capability IE.

TABLE 1

| | |
|---|---|
| --ASN1START..... MeasParameter-v1530 ::= | SEQUENCE {qoe-MeasReport- |

r15
ENUMERATED {supported} OPTIONAL, qoe-MTSI-MeasReport-r15
ENUMERATED {supported} OPTIONAL, ca-IdleModeMeasurements-r15
ENUMERATED {supported} OPTIONAL, ca-IdleModeValidityArea-r15
ENUMERATED {supported} OPTIONAL, heightMeas-r15 ENUMERATED
{supported} OPTIONAL, multipleCellsMeasExtension-r15
ENUMERATED {supported} OPTIONAL}.....

The heightMeas-r15 field defines whether a UE supports height-based measurement reporting defined in TS 36.331. As defined in TS 23.401, to support this function with respect to a UE having aerial UE subscription is essential. The multipleCellsMeasExtension-r15 field defines whether a UE supports measurement reporting triggered based on a plurality of cells. As defined in TS 23.401, to support this function with respect to a UE having aerial UE subscription is essential.

UAV UE Identification

A UE may indicate a radio capability in a network which may be used to identify a UE having a related function for supporting a UAV-related function in an LTE network. A permission that enables a UE to function as an aerial UE in the 3GPP network may be aware based on subscription information transmitted from the MME to the RAN through S1 signaling. Actual “aerial use” certification/license/restriction of a UE and a method of incorporating it into subscription information may be provided from a Non-3GPP node to a 3GPP node. A UE in flight may be identified using UE-based reporting (e.g., mode indication, altitude or location information during flight, an enhanced measurement reporting mechanism (e.g., the introduction of a new event) or based on mobility history information available in a network.

Subscription Handling for Aerial UE

The following description relates to subscription information processing for supporting an aerial UE function through the E-UTRAN defined in TS 36.300 and TS 36.331. An eNB supporting aerial UE function handling uses information for each user, provided by the MME, in order to determine whether the UE can use the aerial UE function. The support of the aerial UE function is stored in subscription information of a user in the HSS. The HSS transmits the information to the MME through a location update message during an attach and tracking area update procedure. A home operator may cancel the subscription approval of the user for operating the aerial UE at any time. The MME supporting the aerial UE function provides the eNB with subscription information of the user for aerial UE approval through an S1 AP initial context setup request during the attach, tracking area update and service request procedure.

An object of an initial context configuration procedure is to establish all required initial UE context, including E-RAB context, a security key, a handover restriction list, a UE radio function, and a UE security function. The procedure uses UE-related signaling.

In the case of Inter-RAT handover to intra- and inter-MME S1 handover (intra RAT) or E-UTRAN, aerial UE subscription information of a user includes an S1-AP UE context modification request message transmitted to a target BS after a handover procedure.

An object of a UE context change procedure is to partially change UE context configured as a security key or a subscriber profile ID for RAT/frequency priority, for example. The procedure uses UE-related signaling.

In the case of X2-based handover, aerial UE subscription information of a user is transmitted to a target BS as follows:

If a source BS supports the aerial UE function and aerial UE subscription information of a user is included in UE context, the source BS includes corresponding information in the X2-AP handover request message of a target BS.

An MME transmits, to the target BS, the aerial UE subscription information in a Path Switch Request Acknowledge message.

An object of a handover resource allocation procedure is to secure, by a target BS, a resource for the handover of a UE.

If aerial UE subscription information is changed, updated aerial UE subscription information is included in an S1-AP UE context modification request message transmitted to a BS.

Table 2 is a table showing an example of the aerial UE subscription information.

TABLE 2

| IE/Group Name | Presence | Range | IE type and reference |
|---|---|---|---|
| Aerial UE | M | | ENUMERATED |
| subscription | | | (allowed, not allowed, . . .) |
| information | | | |

Aerial UE subscription information is used by a BS in order to know whether a UE can use the aerial UE function.

Combination of Drone and eMBB

A 3GPP system can support data transmission for a UAV (aerial UE or drone) and for an eMBB user at the same time.

A base station may need to support data transmission for an aerial UAV and a terrestrial eMBB user at the same time under a restricted bandwidth resource. For example, in a live broadcasting scenario, a UAV of 100 meters or more requires a high transmission speed and a wide bandwidth because it has to transmit, to a base station, a captured figure or video in real time. At the same time, the base station needs to provide a requested data rate to terrestrial users (e.g., eMBB users). Furthermore, interference between the two types of communications needs to be minimized.

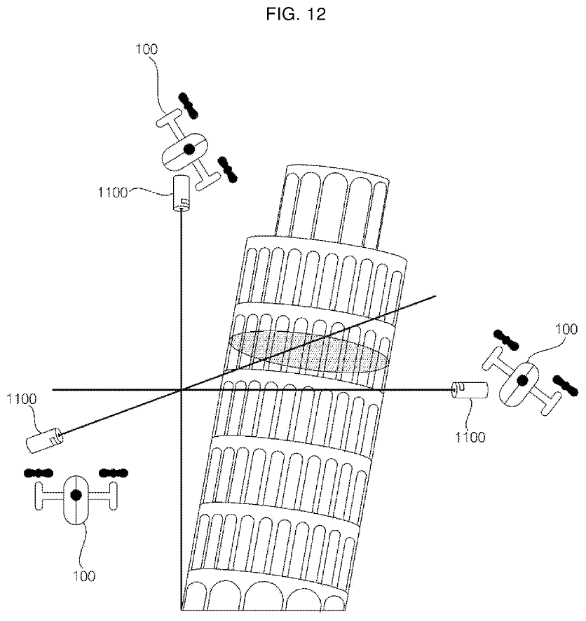

FIGS. 11 and 12 are views referenced for explanation of an example of using an unmanned aerial vehicle according to an embodiment of the present invention in the field of building construction.

Referring to FIGS. 11 and 12, the unmanned aerial vehicle 100 according to an embodiment of the present invention may include a construction reference guide light source 1100. More preferably, the construction reference guide light source 1100 may be a laser light source having excellent straightness. In addition, the construction standard guide light source 1100 may be tiltable. Accordingly, the unmanned aerial vehicle 100 may generate a construction reference guide irrespective of the surrounding environment with the construction reference guide laser 1100.

The need for digitalization and automation in the construction industry is emerging as an aging population and a decrease in skilled manpower. Accordingly, research and use of BIM (Building Information Modeling) that can be used in various ways such as drawing extraction, process management, construction, and risk prediction through digital three-dimensional information (3D) including various construction information such as materials, processes, specifications, and locations Is increasing.

The BIM information is a 3D-based architectural information modeling having the actual shape and information of a building, and may include information applied in various fields throughout the design/construction/management phase. Therefore, it is possible to predict and manage problems occurring in the design and construction process in advance by using BIM information, which is 3D data during building design and construction.

The unmanned aerial vehicle 100 flies to an area adjacent to a point and an altitude where a guide is required based on BIM information, and then outputs laser light as the construction reference guide laser 1100 to freely guide a specific point in three dimensions. In addition, the unmanned aerial vehicle 100 may provide a laser guide to a point requiring attention during construction and a reference point, and monitor the construction status of an area including the corresponding point. Accordingly, there is an effect that convenience and accuracy may be improved and easily managed during the construction process.

Previously, a guide for construction was created using a laser level. In this case, the support plane of the laser level was affected by the inclination and unevenness of the surface, so it was necessary to adjust the level by using a separate level and a fixing part. In addition, it takes a lot of manpower and time to generate the guide, and it is difficult to guide a specific point in three dimensions, for example, a predetermined height.

According to an embodiment of the present invention, it is possible to generate a guide with an accurate angle regardless of the surrounding environment by accurately controlling the position of the unmanned aerial vehicle 100.

In addition, the unmanned aerial vehicle 100 according to an embodiment of the present invention has the advantage of being able to generate a three-dimensional (z-direction) guide at various angles while flying in the air, and to photograph a large area of a site at a construction site.

By utilizing the unmanned aerial vehicle 100 according to an embodiment of the present invention, it is possible to reduce the cost and time (shorten construction period) for construction.

In addition, it can be used on the ground in the case of a conventional guide device, but when using the unmanned aerial vehicle 100, there is an advantage that it is possible to guide the height direction (z).

The unmanned aerial vehicle 100 according to an embodiment of the present invention may generate a 3D laser guide based on drawing information and location information such as GPS, IMU sensor, and laser sensor.

In addition, according to an embodiment of the present invention, it is possible to provide a guideline necessary for the construction process in a wide area and monitor the construction process using the BIM design model and the unmanned aerial vehicle 100 flying in clusters.

In addition, according to an embodiment of the present invention, it is possible to guide even a situation in which the absolute origin laser is insufficient (a situation in which the ground shape is unbalanced) and construction errors may be reduced by utilizing the unmanned aerial vehicle 100 in swarm flight.

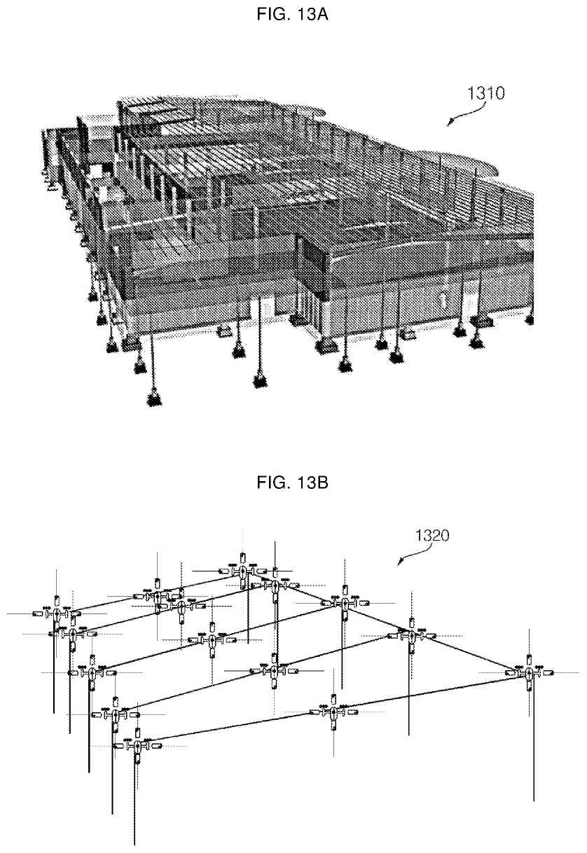

FIGS. 13A and 13B are views referenced for explanation of an example of using a building construction field for swarm flight of unmanned aerial vehicles according to an embodiment of the present invention.

The unmanned aerial vehicle 100 may receive Building Information Modeling (BIM) information 1310 from the server 200 or a BIM server (not shown). In addition, the unmanned aerial vehicle 100 may transmit information photographed with a camera to the server 200 or a BIM server (not shown).

The unmanned aerial vehicle 100 may fly in a swarm in a predetermined formation 1320. In this case, the swarm flight formation 1320 may be determined based on the BIM information 1310.

The unmanned aerial vehicle 100 may provide a construction standard guide based on the BIM information 1310, and the construction state may be checked at the site by photographing the construction state and mapping it to the BIM information 1310.

According to an embodiment of the present invention, since the progress of the construction may be checked in the state that the actual screen photographed by the unmanned aerial vehicle 100 is matched with the BIM information 1310, It is possible to easily identify problems during construction or repair status of defects.

Construction errors occur between the drawing and the actual building at the construction site. The existing guide method (based on the ground) to reduce construction errors requires a lot of cost and time. In addition, the existing guide method (based on the ground) cannot erect a guide in the height direction z.

However, according to an embodiment of the present invention, the drone 100 may perform a guide role as well as monitoring a process. More specifically, the drone 100 may provide a construction guide in three dimensions at a site by using a 3D drawing of the laser and BIM information 1310.

In addition, swarm drones may be used to precisely control location and posture and swarm drones may be used reduce guide errors. In addition, when a plurality of drones 100 are used, construction errors can be reduced.

According to an embodiment of the present invention, even in a situation in which the absolute origin laser based on the ground is insufficient, an accurate guide may be provided while correcting a location error by utilizing a plurality of drones 100.

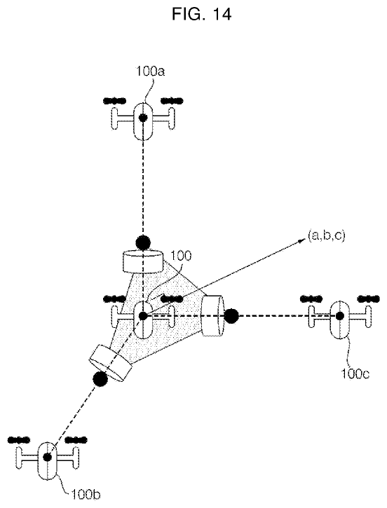

FIGS. 14 to 17 are views referenced for explanation of arrangement of unmanned aerial vehicles using light during swarm flight according to an embodiment of the present invention.

Referring to FIG. 14, it is necessary to create a plane by selecting 3 points in order to define a posture (normal vector (a, b, c)) in 3D.

Just as three points are required to set the normal vector (position) of the plane, the three-point laser must be accommodated to define the posture of the drone 100. For this reason, in the case of the drone 100 in swarm flight, three different drones 100a, 100b, and 100c are required.

Referring to FIGS. 1 and 2, the unmanned aerial vehicle 100 according to an embodiment of the present invention includes a body 20, at least one motor 12 provided in the body 20, and at least one propeller 11 connected to each of the at least one motor 12, a sensing module 130 including at least one sensor, a communication module 175 communicating with other unmanned aerial vehicles, and a task module 40 provided in the main body 20.

The sensing module 130 may include at least one of a gyroscope(gyro sensor), an accelerometer(acceleration sensor), a magnetometer(geomagnetic sensor), a GPS sensor, a camera sensor, and an atmospheric pressure sensor, and may sense a rotational state and a translational state of the unmanned aerial vehicle 100.

The task module 40 may include a module for performing a predetermined task. For example, the task module 40 may include a construction reference laser 1100 for generating a construction reference guide.

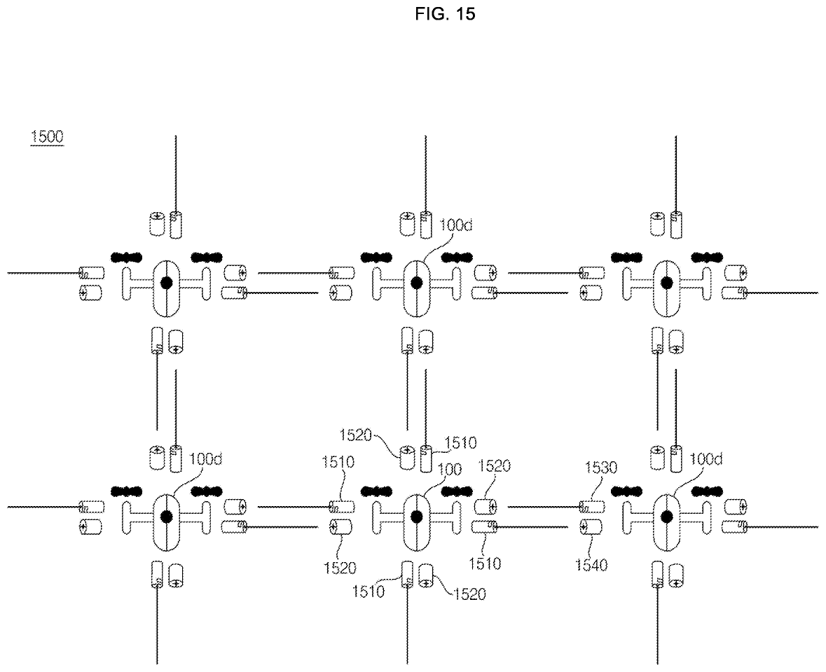

Referring to FIG. 15, the unmanned aerial vehicle 100, 1500 may include a light emitting module 1510 that outputs light in at least three directions, and light reception module 1520 receives light output from a light emitting module 1530 of some of the unmanned aerial vehicles 1500 in swarm flight.

The light emitting module 1510 outputs light that helps to determine the location of another unmanned aerial vehicle, and may output light in at least three directions. To this end, the unmanned aerial vehicle 100 may include at least three pairs or more of the light emitting module and the light reception module.

More preferably, the light emitting module 1510 may use a laser light source having excellent straightness and may output light in three directions.

Depending on the embodiment, the light emitting module 1510 and the light reception module 1520 may be implemented in the form of a laser sensor module and provided in the sensing module 130.

Alternatively, the light emitting module 1510 and the light reception module 1520 may be mounted as modules for swarm flight in the task module 40 provided to perform the work of the unmanned aerial vehicle 100.

Referring to FIG. 15, the light output from the light emitting modules 1510 and 1530 of the unmanned aerial vehicle 100 and 100d may be received by the light reception modules 1520 and 1540 of the other unmanned aerial vehicle 100d and 100.

Meanwhile, pairs of the light emitting modules 1510 and 1530 and the light reception modules 1520 and 1540 may have the same separation distance and an arrangement direction between the light emitting modules 1510 and 1530 and the light reception modules 1520 and 1540.

For example, the separation distance and arrangement direction of the pair of the light emitting module 1510 and the light reception module 1520 provided in the unmanned aerial vehicle 100 and the separation distance and arrangement direction of the pair of the light emitting module 1530 and the light reception module 1540 provided by the unmanned aerial vehicle 100d may be the same. Accordingly, alignment between the light emitting modules 1510 and 1530 of one unmanned aerial vehicle 100 and 100d and the light reception modules 1520 and 1540 of the other unmanned aerial vehicle 100d and 100 may be performed more simply and easily.

The light emitting modules 1510 and 1530/the light reception modules 1520 and 1540 may be arranged identically based on the direction, in order to eliminate confusion and ambiguity in the arrangement of the light emitting modules 1510 and 1530/the light reception modules 1520 and 1540.

For example, as shown in FIG. 15, the light emitting modules 1510 and 1530 are disposed on the right side and the light reception modules 1520 and 1540 are disposed on the left side in the facing direction of the light emitting modules 1510 and 1530/the light reception modules 1520 and 1540.

Meanwhile, as described with reference to FIG. 14, three constraints are required to control the tilting of one unmanned aerial vehicle 100.

Therefore, in case of a swarm flight, when there are at least 8 unmanned aerial vehicles 100, it is possible to control the tilting of the entire unmanned aerial vehicle 100.

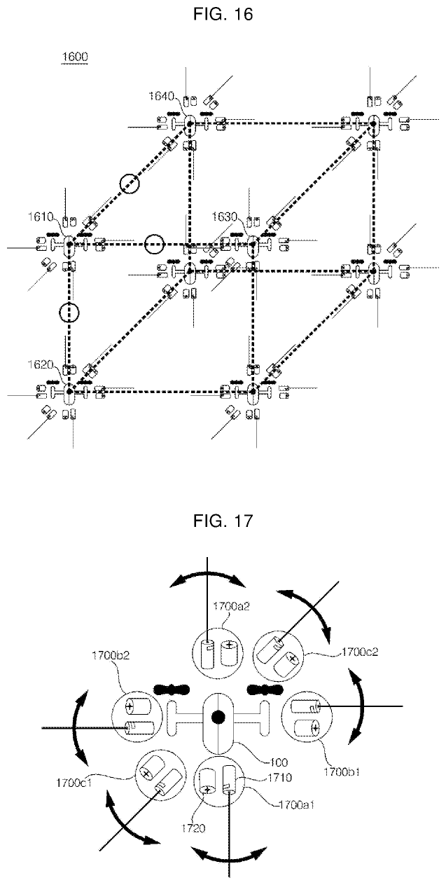

Referring to FIG. 16, it is necessary to receive a laser in three directions in order to determine the location and control the tilting of any one of the unmanned aerial vehicles 1600 in a swarm flight. The unmanned aerial vehicle 1610 may receive light from the unmanned aerial vehicles 1620, 1630, and 1640 positioned in the 3-axis direction on the formation. To this end, the unmanned aerial vehicles 1610, 1620, 1630, and 1640 require three or more laser modules per unit.

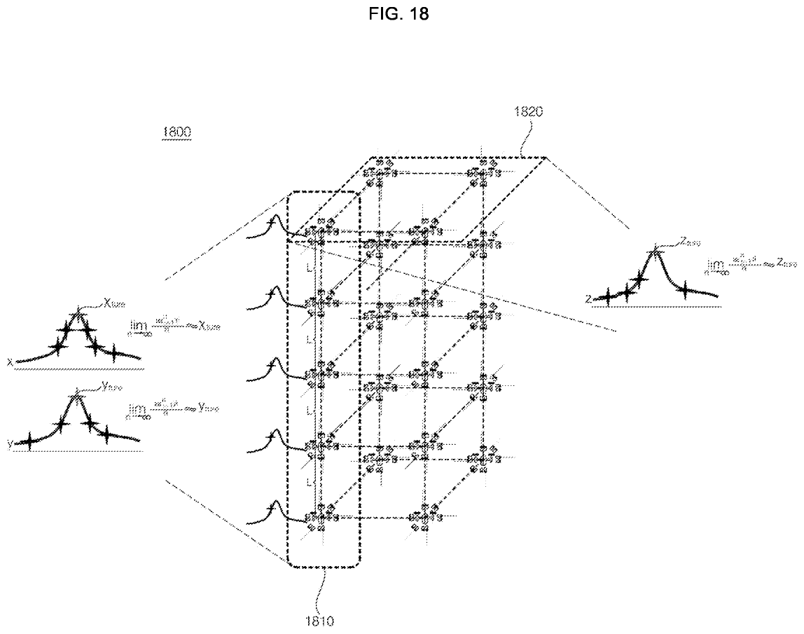

Referring to FIG. 17, laser modules 1700a1, 1700a2, 1700b1, 1700b2, 1700c1, and 1700c2 including a light emitting module 1710 and a light reception module 1720 may be tiltable. Accordingly, the laser modules 1700a1, 1700a2, 1700b1, 1700b2, 1700c1, and 1700c2 output light in the axial direction and then tilt at a predetermined angle to form more various formations.

Meanwhile, that the unmanned aerial vehicle 1610 receives the light output from the other unmanned aerial vehicles 1620, 1630, and 1640 may mean that they are aligned on a straight line.

In this way, the error can be reduced by aligning the basic unmanned aerial vehicles 1610, 1620, 1630, 1640 using light and complementing the location information of each unmanned aerial vehicle 1610, 1620, 1630, 1640.

Hereinafter, a method of determining and correcting a location error will be described with reference to FIGS. 18 to 26.

FIG. 18 is a view referenced for explanation of mutual error correction during swarm flight according to an embodiment of the present invention.

Referring to FIG. 18, some of the unmanned aerial vehicles 1800 in swarm flight by forming a predetermined formation may be aligned and disposed on the same axis 1810 and 1820 in the formation. For example, some unmanned aerial vehicles are aligned based on the Z-axis 1810, and the X and Y-axis coordinates on the formation may be the same. Some unmanned aerial vehicles are aligned with respect to the X and Y axes (or horizontal plane, 1820), so that the Z axis coordinates on the formation may be the same.

In the unmanned aerial vehicle system according to an embodiment of the present invention, the unmanned aerial vehicles 1800 in swarm flight may receive light from other unmanned aerial vehicles located in the 3-axis direction on the formation.

That one unmanned aerial vehicle 100 receives light output from other unmanned aerial vehicles may mean that they are aligned on a straight line.

The unmanned aerial vehicles disposed on the same axes 1810 and 1820 have the same coordinates of at least one axis in the formation.

Thereafter, the unmanned aerial vehicle 100 may share the location information based on the sensing data of the sensing module with the unmanned aerial vehicle that outputs the received light at least among the unmanned aerial vehicles 1800 in swarm flight through the communication module 175. They are aligned on a straight line, so that sensing data can be shared between unmanned aerial vehicles. Accordingly, data may be collected between unmanned aerial vehicles set to be aligned in the vertical and horizontal directions in the formation.

At least one unmanned aerial vehicle among the unmanned aerial vehicles 1800 in swarm flight may collect a plurality of shared location information to determine a location error, and perform a flight to correct the determined location error.

For example, the processor 411 of any one unmanned aerial vehicle 100 may collect a plurality of the shared position information to determine a location error, and control the motor 12 to perform a flight to correct the determined location error.

Meanwhile, as described with reference to FIG. 4, the unmanned aerial vehicle 100 may be defined as a first communication device 10, and the processor 411 may perform detailed operations of the unmanned aerial vehicle 100. In this case, the processor 411 may correspond to the processor 140 of FIG. 2. In addition, what is described as the operation of the processor 411 in this specification may be replaced with the operation of the processor 140.

Meanwhile, the processor 411 may determine the location error based on a probability distribution of coordinate information collected from unmanned aerial vehicles aligned on the same axes 1810 and 1820 in a formation of a swarm flight.

The unmanned aerial vehicle system including the unmanned aerial vehicles 1800 in swarm flight according to an embodiment of the present invention may share sensing data and/or coordinate information based on the sensing data between unmanned aerial vehicles aligned on the same axis 1810 and 1820.

The processor 411 of one or more unmanned aerial vehicles 100 may collect z-axis coordinate information with unmanned aerial vehicles arranged on the same layer 1820 among unmanned aerial vehicles arranged on the same axis 1810 and 1820, and, collect x and y-axis coordinate information with unmanned aerial vehicles aligned with other layers 1810 in the formation of the swarm flight.

Meanwhile, errors may be compensated for through summation and probability/statistics of sensor values of a number of unmanned aerial vehicles.

Referring to FIG. 18, the collected data increases as the number of unmanned aerial vehicles 1800 increases, and the distribution of the average for each axis coordinate approaches the normal distribution, so that the true value may be derived according to the Center Limit Theorem (CLT).

The unmanned aerial vehicle system according to an embodiment of the present invention determines whether or not a location error occurs based on the derived true value, and controls to perform a flight that corrects the error, thereby enabling precise control of swarm flight.

On the other hand, the processor 411 of the one or more unmanned aerial vehicles 100 may determine based on the probability distribution of the coordinate information based on the information sensed by the same type sensor of unmanned aerial vehicles that are aligned on the same axis 1810 and 1820 in the formation of the swarm flight.

For example, it is possible to further improve the accuracy of location error determination by comparing data for each of the same position sensors (IMU/GPS/VISION).

On the other hand, the unmanned aerial vehicle system according to an embodiment of the present invention has an advantage that, location error correction is possible through error compensation between the unmanned aerial vehicles 100 without a reference laser value in the absence of an absolute reference (ground) laser. In this case, the error compensation effect may increase as the number of unmanned aerial vehicles 100 increases.

The unmanned aerial vehicle 100 according to an embodiment of the present invention may receive output light of a light source corresponding to absolute reference information including fixed coordinate information through the light reception module 1520. In this case, the processor 411 may determine the current location based on the absolute reference information.

That is, when there is a laser that provides absolute reference coordinates on the ground and light is received from the absolute reference laser, the unmanned aerial vehicle 100 may determine the current location based on the absolute reference coordinate.

In addition, in the unmanned aerial vehicle system according to an embodiment of the present invention, when there is an absolute reference (ground) laser, the value may be updated with reference to the absolute reference laser value. However the measurement error accumulates as the distance from the absolute reference laser (from the ground or horizontally) increases, so the accuracy of the swarm flight precision control may be further improved by determining and correcting the location error based on the probability distribution of coordinate information.

According to an embodiment, a plurality of location information shared by all of the unmanned aerial vehicles 1800 in swarm flight may be collected to determine a location error, and a flight may be performed to correct the determined location error. That is, all of the unmanned aerial vehicles 1800 in swarm flight may perform a mutual error correction process.

According to an exemplary embodiment, a plurality of location information shared by some of the unmanned aerial vehicles 1800 in swarm flight may be collected to determine a location error, and a flight may be performed to correct the determined location error.

In this case, the location error may be corrected by aligning the remaining unmanned aerial vehicles with the unmanned aerial vehicle correcting the location error.

Alternatively, the unmanned aerial vehicle correcting the location error may transmit the information on the determined location error to the unmanned aerial vehicle outputting the received light, that is, an unmanned aerial vehicle positioned on a straight line. Upon receiving the information on the location error, the unmanned aerial vehicle may correct the location error based on the received information.

An unmanned aerial vehicle (UAV) according to an embodiment disclosed in the present specification may recognize at least some of the light output from the light sources of other unmanned aerial vehicles in swarm flight, and correct a location error based on the recognized light. have.

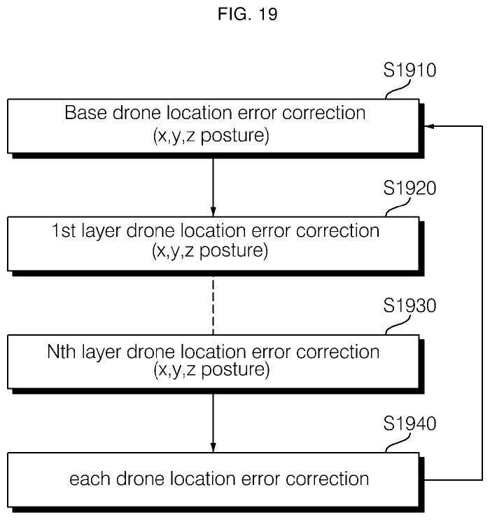

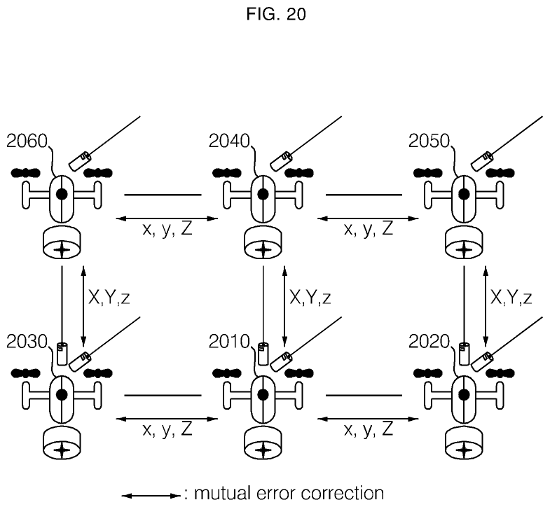

FIG. 19 is a flowchart illustrating a method of correcting a location error during a swarm flight according to an embodiment of the present invention. FIG. 20 is a diagram referenced for explanation of the location error correction method of FIG. 19.

Referring to FIGS. 19 and 20, swarm drones 2010, 2020, 2030, 2040, 2050, and 2060 may be used to reduce guide errors as well as precise location and posture control.

Swarm drones 2010, 2020, 2030, 2040, 2050, 2060 may share coordinate information of different axes among drones located on the same axis.

Location error correction of the swarm drones 2010, 2020, 2030, 2040, 2050, and 2060 may be performed sequentially based on the criteria of a layer, a row, and a column.

First, a base drone location error correction, which is at least one of the drones 2010, 2020, 2030 disposed on the lowest first layer, is performed (S1910), and the location error correction of the drones 2010, 2020, 2030 disposed on the lowest first layer, and 2030 may be performed (S1920). In some cases, all of the drones 2010, 2020, 2030 arranged on the 1st layer may be selected as the base drone.

As described with reference to FIG. 18, the correction of the location error between the drones may be performed based on a statistically derived true value by collecting sensing data and/or position coordinate data between drones located on the same axis.

Thereafter, location error correction may be performed sequentially from the drones 2040, 2050, and 2060 disposed in the second layer above the 1st layer to the drones (not shown) disposed in the Nth layer (S1930).

If location error correction is performed up to the drones (not shown) arranged in the Nth layer, finally, location error correction of each swarm drone 2010, 2020, 2030, 2040, 2050, 2060 may be performed (S1940).

According to an exemplary embodiment of the present invention, by using a plurality of swarm drones, an error may be reduced compared to a case of using a single drone. In addition, according to an embodiment of the present invention, a plurality of construction guide lasers may be set, and construction guides are possible in the height direction z.

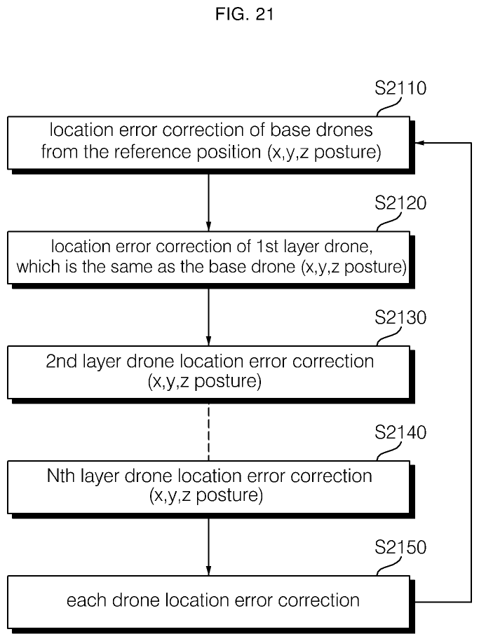

FIG. 21 is a flowchart illustrating a method of correcting a location error during a swarm flight according to an embodiment of the present invention.

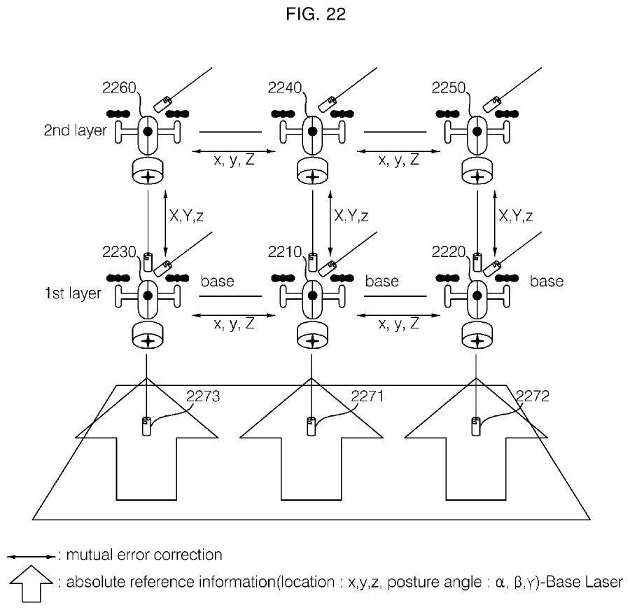

FIG. 22 is a diagram referenced for explanation of the location error correction method of FIG. 21.

Referring to FIGS. 21 and 22, a plurality of absolute reference lasers 2271, 2272, and 2273 may be used in a flat terrain.

Referring to FIGS. 21 and 22, at least one of the unmanned aerial vehicles 2210, 2220, 2230 arranged in the 1st layer of the lowest altitude in the formation of the swarm flight may receive the output light of the light sources 2271, 2272, and 2273 corresponding to the absolute reference information including fixed coordinate information, and may determine a current location based on the absolute reference information.

In addition, the unmanned aerial vehicles 2210, 2220, and 2230 that received the output light of the light sources 2271, 2272, and 2273 corresponding to the absolute reference information may perform location error correction based on the absolute reference information (S2110).

Location error correction of the swarm drones 2210, 2220, 2230, 2240, 2250, and 2260 may be performed sequentially based on the criteria of a layer, a row, and a column.

At least some of the other unmanned aerial vehicles may correct the location error based on the base unmanned aerial vehicle that has determined the current location based on the absolute reference information.

For example, unlike the example of FIG. 22, unless all of the drones 2210, 2220, and 2230 arranged on the 1st layer have received the output light of the light sources 2271, 2272, and 2273 corresponding to the absolute reference information, location error correction of the drones disposed in the 1st layer based on the base drone may be additionally performed (S2120).

Thereafter, location error correction may be sequentially performed from the drones 2240, 2250, and 2260 disposed on the 2nd layer above the 1st layer to the drones (not shown) disposed on the Nth layer (S2130 and S2140).

When the location error correction is performed to the drones (not shown) disposed on the Nth layer, the location error correction of each of the swarm drones 2210, 2220, 2230, 2240, 2250, 2260 may be finally performed (S2150).

Referring to FIGS. 21 and 22, the unmanned aerial vehicle system may correct the location error using a plurality of absolute reference lasers 2271, 2272, 2273 on a flat terrain, and use complementarily swarm drones 2210, 2220, 2230, 2240, 2250, 2260 in order to reduce guide error, and the precision location/posture control.

According to an embodiment, the unmanned aerial vehicles 2210, 2220, and 2230 arranged in the lowest altitude first layer in the formation of the swarm flight may receive output light of light sources 2271, 2272, and 2273 corresponding to absolute reference information including fixed coordinate information, determine a current location based on the absolute reference information, and perform location error correction.

The unmanned aerial vehicles 2240, 2250, and 2260 arranged on the second layer higher than the first layer may correct location error based on the unmanned aerial vehicles 2210, 2220, 2230 of the first layer aligned on the same z-axis, respectively.

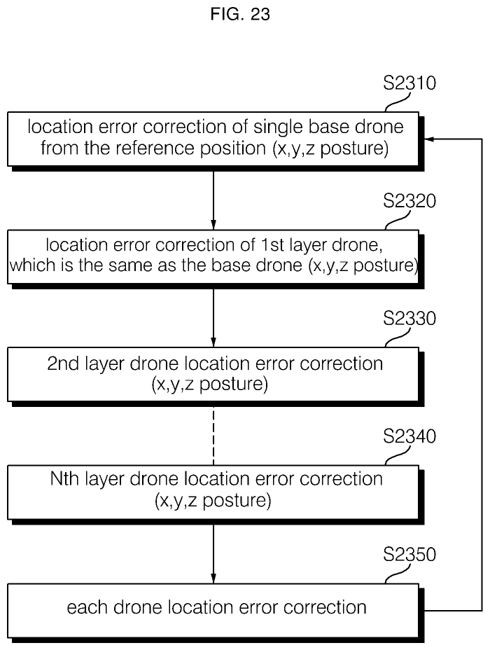

FIG. 23 is a flowchart illustrating a method of correcting a location error during a swarm flight according to an embodiment of the present invention.

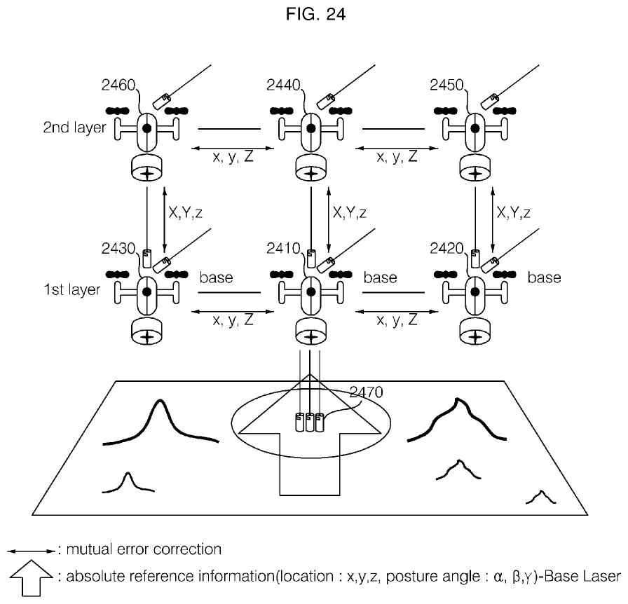

FIG. 24 is a diagram referenced for explanation of the location error correction method of FIG. 23.

Referring to FIGS. 23 and 24, one or a few absolute reference lasers 2470 may be used in an environment in which the terrain is unbalanced.

Referring to FIGS. 23 and 24, at least one unmanned aerial vehicle 2410 among unmanned aerial vehicles 2410, 2420, and 2430 arranged in the 1st layer of the lowest altitude in the formation of a swarm flight may receive, the output light of the light source 2270 corresponding to absolute reference information including fixed coordinate information, and determine a current location based on the absolute reference information.

In addition, the unmanned aerial vehicle 2410 receiving the output light of the light source 2270 corresponding to the absolute reference information may perform location error correction based on the absolute reference information (S2310).

Location error correction of the swarm drones 2410, 2420, 2430, 2440, 2450, and 2460 may be performed sequentially based on the criteria of a layer, a row, and a column.

At least some of the other unmanned aerial vehicles may correct the location error based on the base drone 2410 that has determined the current location based on the absolute reference information.

For example, location error correction of the drones 2420 and 2430 disposed on the 1st layer may be additionally performed based on the base drone 2410 (S2320).

Thereafter, location error correction may be sequentially performed from the drones 2440, 2450, and 2460 disposed on the 2nd layer above the 1st layer to the drones (not shown) disposed on the Nth layer (S2330 and S2340).

When the location error correction is performed to the drones (not shown) arranged in the Nth layer, the location error correction of each swarm drone 2410, 2420, 2430, 2440, 2450, 2460 may be finally performed (S2350).

Referring to FIGS. 23 and 24, the unmanned aerial vehicle system may correct the location error using one or a few absolute reference lasers 2470 in an environment where the terrain is unbalanced, are used to correct the location error, and use complementarily swarm drones 2410, 2420, 2430, 2440, 2450, 2460 in order to reduce guide error, and the precision location/posture control.

According to an embodiment, the remaining unmanned aerial vehicles 2420 and 2430 aligned with the first layer correct the location error based on the first unmanned aerial vehicle 2410, which is one of the unmanned aerial vehicles 2410, 2420, and 2430 arranged in the lowest altitude first layer in the formation of the swarm flight, and the second unmanned aerial vehicle 2440 aligned on the same z-axis as the first unmanned aerial vehicle 2410 among the unmanned aerial vehicles 2240, 2250 and 2260 arranged in a second layer higher than the first layer may correct a location error based on the first unmanned aerial vehicle 2410.

Thereafter, the remaining unmanned aerial vehicles 2250 and 2260 arranged with the second layer may correct the location error based on the second unmanned aerial vehicle 2440.

In addition, the first unmanned aerial vehicle 2410 may receive the output light of the light source 2470 corresponding to absolute reference information including fixed coordinate information, determine the current location based on the absolute reference information, and correct the determined error.

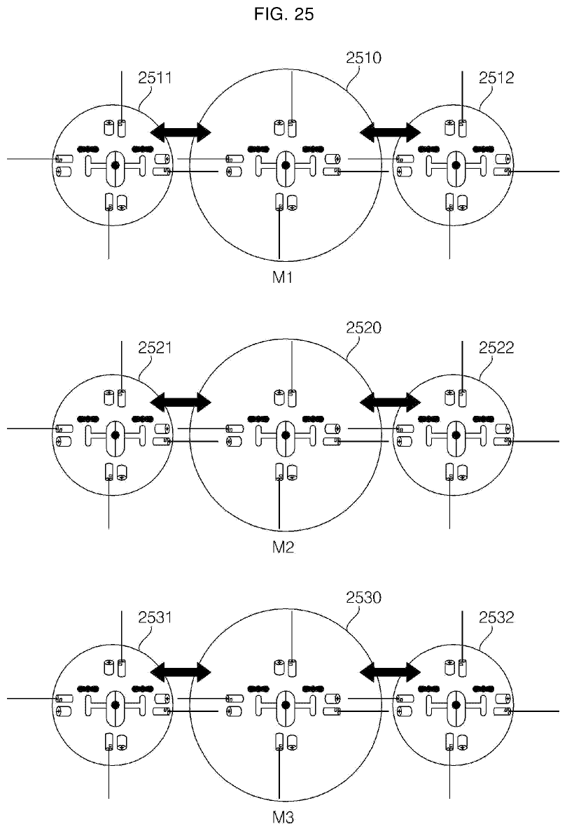

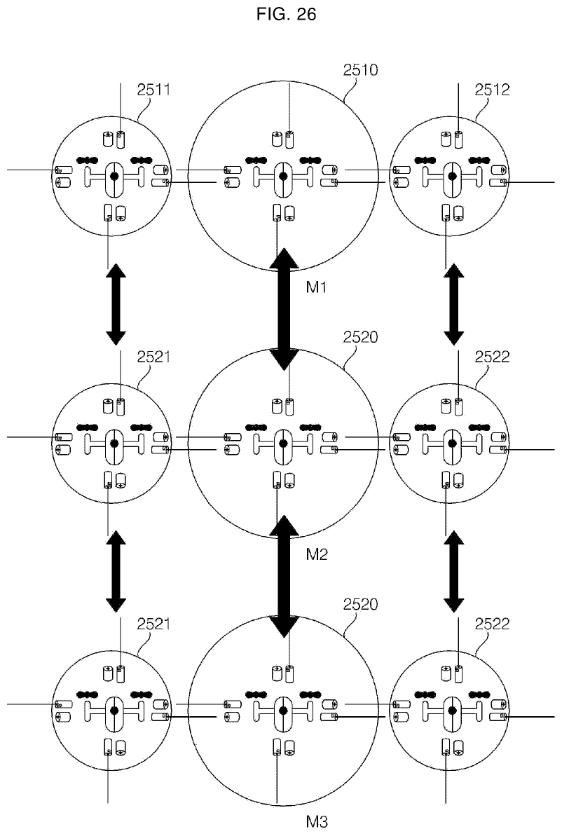

FIGS. 25 and 26 are views referenced for explanation of a method for forming a swarm flight formation according to an embodiment of the present invention.

Referring to FIGS. 25 and 26, a plurality of drones disposed at the same altitude during formation may form a small group in a swarm.

For example, the first base drone 2510, and two drones 2511, 2512 around the first base drone 2510 form the first group, and around the second base drone 2520, and two drones 2521, 2522 around the second base drone 2520 form the second group, and the third base drone 2530 and two drones 2531, 2532 centering on the third base drone 2530 may form the third group.

The unmanned aerial vehicles of each small group arranged in a layer of the same altitude, may correct location error based on any one base unmanned aerial vehicle.

For example, two drones 2511, 2512 may correct the location error based on the first base drone 2510, and, two drones 2521, 2522 may correct error based on the second base drone 2520. The two drones 2531 and 2532 may correct the location error based on the third base drone 2530.

Thereafter, the base drones 2510, 2520, and 2530 may adjust the distance between them. Thereafter, the drones 2511, 2512, 2521, 2522, 2531, and 2532 of the small group may correct the location error based on each of the base drones 2510, 2520, and 2530.

In another embodiment, first, the base drones 2510, 2520, and 2530 may adjust the distance between each other. Thereafter, the drones 2511, 2512, 2521, 2522, 2531, and 2532 of the small group may correct the location error based on each of the base drones 2510, 2520, and 2530.

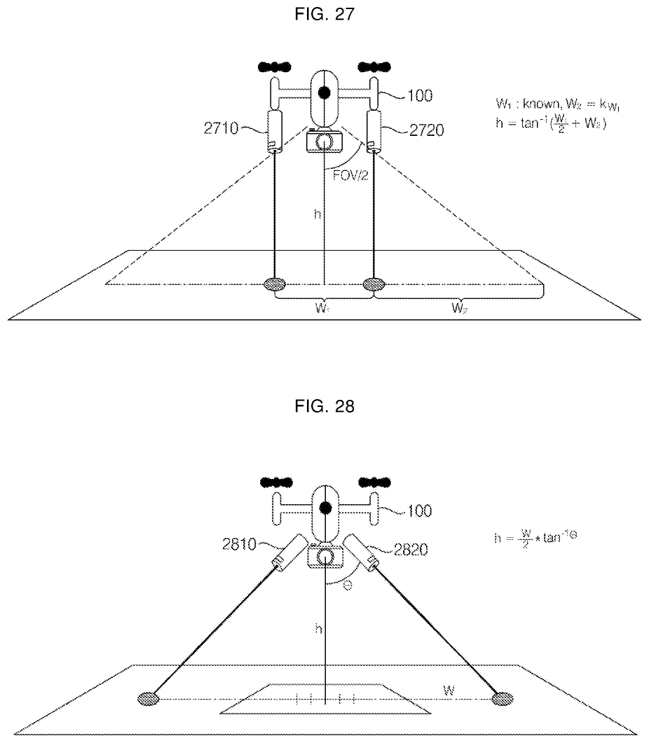

FIGS. 27 to 29 are diagrams referenced for description of distance(and altitude) determination methods according to various embodiments of the present disclosure.

Referring to 27 and 28 illustrate examples of a camera/laser combination for measuring and controlling a lengthwise error between the unmanned aerial vehicle 100 (Master to Slave/Slave to Slave).

Referring to FIG. 27, the distance h can be obtained using the camera field of view (FOV) of the unmanned aerial vehicle 100 and the arrangement shape of the laser light sources 2710 and 2720.

The interval W1 of the laser light sources 2710 and 2720 is a known value, and W2 can be relatively measured based on the interval W1. Therefore, the distance h may be calculated using the shown equation.

If one laser light source is provided, the distance h may be calculated using the W½ value instead of the interval W1.

FIG. 28 illustrates a case in which one tiltable laser light source 2810 is used.

As shown in FIG. 28, θ can be obtained by rotating the laser light source 2810. Thus, when W is known, the distance h can be calculated.

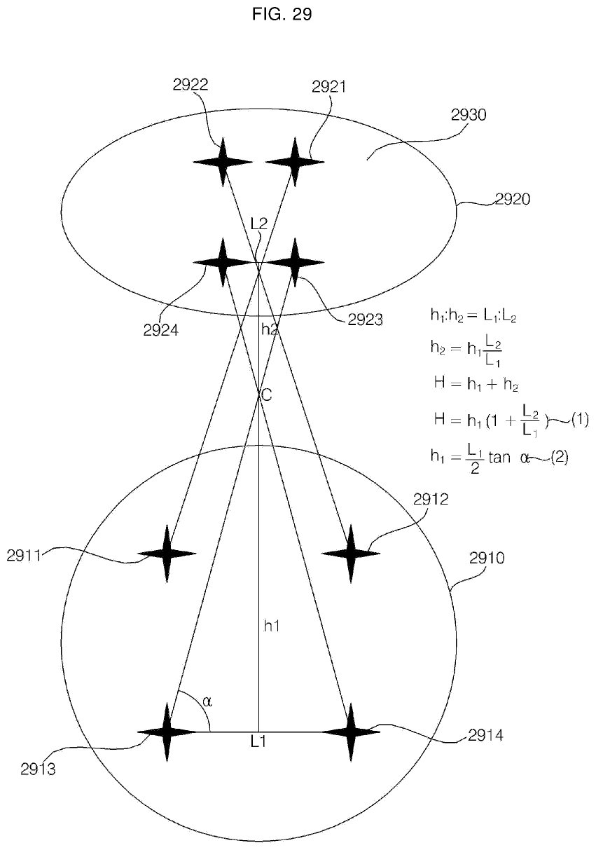

Referring to FIG. 29, light sources 2911, 2912, 2913, and 2914 disposed on the ground surface 2900 may output light inclined at a predetermined angle (90°-α) in a vertical direction. In addition, the arranged light sources 2911, 2912, 2913, and 2914 may have at least one of modulation information of at least one of a frequency, a size, and a length of the output light differently set.

The unmanned aerial vehicle 100 may recognize the light sources 2911, 2912, 2913, and 2914 upwardly output the lights 2921, 2322, 2323, and 2324 which different modulation information is set through the light reception module 2920.

The processor 411 may identify the light sources 2911, 2912, that outputs each of the lights 2921, 2322, 2323, 2324 according to the modulation information (eg, frequency information).

In addition, the processor 411 may determine the location of the unmanned aerial vehicle 100 based on the location information of the identified light sources 2911, 2912, 2913, and 2914.

In addition, the processor 411 may determine the arrangement type of the light sources 2911, 2912, 2913, 2914 using the location information of the light sources 2911, 2912, 2913, 2914, and check the posture of the unmanned aerial vehicle 100 (horizontal level, the heading direction of the unmanned aerial vehicle 100 (yaw)) using this arrangement type.

According to an embodiment of the present invention, it is also possible to calculate the height of the Z-axis altitude by using light with strong straightness that is output obliquely. For example, a laser beam whose output direction is tilted based on the ground or vertical direction is used as the light sources 2911, 2912, 2913, 2914, it is possible to calculate the height of the Z-axis altitude/height(H).

The Z-axis altitude/height (H) is the sum of the first height (h1) which is the height of the intersection point (C) where lights cross, and the second height (h2) which is the distance from the intersection point (C) to the unmanned aerial vehicle 100. In this case. the height (h1) of the intersection point (C) is calculated by substituting the angle at which the light is inclined (a) with respect to the ground 2900 or the landing surface and the distance L1 between the light source into the trigonometric function of equation (2).

In addition, the distance L1 between the light sources and the distance L2 of the corresponding lights on the light reception module 2920 have a proportional relationship with the first height h1 and the second height h2.

Accordingly, as shown in FIG. 29, the calculation formula of the Z-axis altitude/height (H) may be summarized by Equation (1), and the processor 411 may finally calculate the Z-axis altitude/height(H), since the distance L2, the distance L1 between the light sources and the corresponding light on the light reception module 2920, the angle a which the light is inclined based on the ground 2900 be known.

The calculation formula described with reference to FIG. 29 is exemplary, and other formulas may be used.

When only a straight laser that outputs light in the vertical direction is used, information on the distance cannot be obtained, but the present embodiment has a feature that information on the distance can be obtained by tilting the laser.

Accordingly, at least some of the plurality of light sources may output light in a direction inclined at a predetermined angle from the landing surface or the vertical direction of the ground, and the height of the unmanned aerial vehicle 100 may be calculated using this.

In addition, some of the plurality of light sources output light in a direction perpendicular to the landing surface or the ground, and some of the plurality of light sources output light in a direction inclined at a predetermined angle from the landing surface or in the vertical direction of the ground.

If the light output to go straight in the vertical direction is used, since there is no calculation process related to the angle, it is possible to determine the location and posture more quickly. However, the height cannot be calculated.

Therefore, the light output directions can be used in combination. That is, location and posture control may be performed more precisely and conveniently using light output in the vertical direction, and altitude may be accurately calculated using light output in a direction inclined at a predetermined angle from the vertical direction.

According to an embodiment of the present invention, it is possible to measure and control a more accurate posture and distance through a combination of an inclined laser and a vertical straight laser.

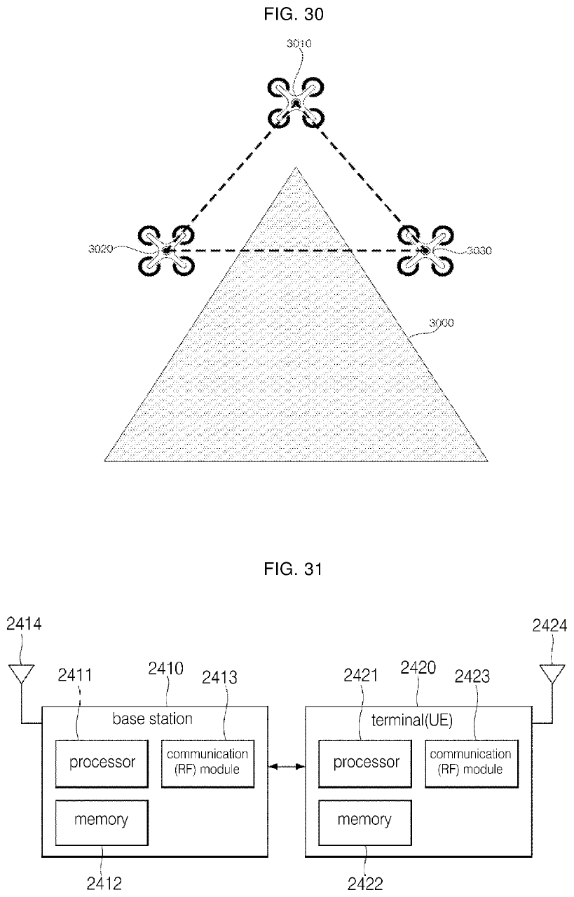

FIG. 30 is a diagram referred to for description of an unmanned aerial vehicle alignment using a laser, and is a top view of a plurality of drones 3010, 3020, 3030 and a structure 3000.

In the present invention, drones on the same layer may be aligned using a laser. Accordingly, even if the communication connection between the aircraft is disconnected, basic alignment using light is possible.

In addition, Drones of different layers can also be aligned with each other using a laser that is arranged in the vertical direction.

Referring to FIG. 30, even when two drones 3020, 3030 among the plurality of drones 3010, 3020, 3030 are obscured by the structure 3000, the two drones 3020, 3030 also exist on the upper and lower sides. If it aligns with a drone (not shown), the formation may be maintained.

General Device to which the Present Invention is Applicable

FIG. 31 shows a block diagram of a wireless communication device according to an embodiment of the present invention.

Referring to FIG. 31, a wireless communication system includes a base station (or network) 3110 and a terminal 3120.

Here, the terminal may be a UE, a UAV, an unmanned aerial robot, a wireless aerial robot, or the like.

The base station 3110 includes a processor 3111, a memory 3112, and a communication module 3113.

The processor executes the functions, processes, and/or methods described in FIGS. 1 to 30. Layers of wired/wireless interface protocol may be implemented by the processor 3111. The memory 3112 is connected to the processor 3111 and stores various information for driving the processor 3111. The communication module 3113 is connected to the processor 3111 to transmit and/or receive a wired/wireless signal.

The communication module 3113 may include a radio frequency (RF) unit for transmitting/receiving a wireless signal.

The terminal 3120 includes a processor 3121, a memory 2422, and a communication module (or RF unit) 3123. The processor 3121 executes the functions, processes, and/or methods described in FIGS. 1 to 30. Layers of wireless interface protocol may be implemented by the processor 3121. The memory 3122 is connected to the processor 3121 and stores various information for driving the processor 3121. The communication module 3123 is connected to the processor 3121 to transmit and/or receive a wireless signal.

The memories 3112 and 3122 may be located inside or outside the processors 3111 and 3121, and may be connected to the processors 3111 and 3121 by well-known various means.

In addition, the base station 3110 and/or the terminal 3120 may have a single antenna or multiple antennas.

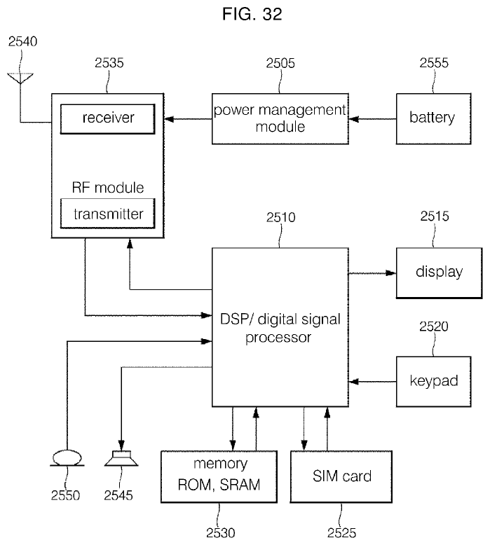

FIG. 32 is a block diagram of a communication device according to an embodiment of the present invention.

In particular, FIG. 32 shows the terminal of FIG. 31 in more detail.

Referring to FIG. 32, the terminal may be configured to include a processor (or a digital signal processor (DSP)) 3210, an RF module (or an RF unit) 3235, or a power management module 3205, an antenna 3240, a battery 3255, a display 3215, a keypad 3220, a memory 3230, a subscriber identification module (SIM) card 3225 (this configuration is optional), a speaker 3245, and a microphone 3250. In addition, the terminal may include a single antenna or multiple antennas.

The processor 3210 executes the functions, processes, and/or methods described in FIGS. 1 to 31. Layers of wireless interface protocol may be implemented by the processor 3210.

The memory 3230 is connected to the processor 3210 and stores information related to an operation of the processor 3210. The memory 3230 may be located inside or outside the processor 3210, and may be connected to the processor 3210 by well-known various means.

For example, the user inputs command information such as a telephone number by pressing (or touching) a button on the keypad 3220 or by voice activation using the microphone 3250. The processor 3210 executes and processes proper functions such as receiving the command information or dialing a telephone number. Operational data may be extracted from the SIM card 3225 or the memory 3230. In addition, the processor 3210 may display command information or driving information on the display 3215 for the user to recognize and for convenience.

The RF module 3235 is connected to the processor 3210 to transmit and/or receive an RF signal. For example, the processor 3210 transmits command information to the RF module 3235 to transmit a wireless signal constituting voice communication data to initiate communication. The RF module 3235 includes a receiver and a transmitter for receiving and transmitting a wireless signal. The antenna 3240 functions to transmit and receive a wireless signal. When the wireless signal is received, the RF module 3235 may transmit the signal and convert the signal to a baseband for processing by the processor 3210. The processed signal may be converted into audible or readable information output through the speaker 3245.

The embodiment according to the present invention may be implemented by various means, for example, hardware, firmware, software, or a combination thereof. In the case of implementation by hardware, an embodiment of the present invention includes one or more application specific integrated circuits (ASICs), digital signal processors (DSPs), digital signal processing devices (DSPDs), programmable logic devices (PLDs), and FPGAs (field programmable gate arrays), processors, controllers, microcontrollers, microprocessors, etc.

In the case of implementation by firmware or software, an embodiment of the present invention may be implemented in the form of a module, procedure, or function that performs the functions or operations described above. The software code can be stored in a memory and driven by a processor. The memory may be located inside or outside the processor, and may exchange data with the processor through various known means.

It will be appreciated that in the specification, each block of the process flow diagrams and combinations of the flow chart diagrams may be executed by computer program instructions. Since these computer program instructions can be mounted on the processor of a general purpose computer, special purpose computer or other programmable data processing equipment, the instructions executed by the processor of the computer or other programmable data processing equipment are described in the flowchart block(s). It creates a means to perform functions. These computer program instructions can also be stored in computer-usable or computer-readable memory that can be directed to a computer or other programmable data processing equipment to implement a function in a particular way, so that the computer-usable or computer-readable memory It is also possible to produce an article of manufacture containing instruction means for performing the functions described in the flowchart block(s). Computer program instructions can also be mounted on a computer or other programmable data processing equipment, so a series of operating steps are performed on a computer or other programmable data processing equipment to create a computer-executable process to create a computer or other programmable data processing equipment. It is also possible for instructions to perform processing equipment to provide steps for executing the functions described in the flowchart block(s).

In addition, each block may represent a module, segment, or part of code that contains one or more executable instructions for executing the specified logical function(s). In addition, it should be noted that in some alternative execution examples, functions mentioned in blocks may occur out of order. For example, two blocks shown in succession may in fact be executed substantially simultaneously, or the blocks may sometimes be executed in reverse order depending on the corresponding function.

As is apparent from the above description, according to at least one of the embodiments of the present invention, it has the advantage of being able to accurately determine the location of an unmanned aerial vehicle using light and precisely control the unmanned aerial vehicle.

In addition, according to at least one of the embodiments of the present invention, it has the advantage of being able to accurately determine and calibrate an location error of an unmanned aerial vehicle in a swarm flight.

In addition, according to at least one of the embodiments of the present invention, it has the advantage of being able to calibrate sensors even in flight.

In addition, according to at least one of the embodiments of the present invention, it is possible to provide accurate construction guides that are not restricted by the surrounding environment using unmanned aerial vehicles.

It is an object of the present specification to provide a method and apparatus capable of determining the location of an unmanned aerial vehicle using light in an unmanned aerial vehicle and an aerial control system for the unmanned aerial vehicle.

It is another object of the present specification to provide a method and apparatus capable of accurately determining and correcting the location error of unmanned aerial vehicles during swarm flight in the unmanned aerial vehicle and an aerial control system for the unmanned aerial vehicle.

It is another object of the present specification to provide accurate construction guides that are not restricted by the surrounding environment using unmanned aerial vehicles.

In order to accomplish the above and other objects, the unmanned aerial vehicle (UAV) according to an embodiment of the present invention may recognize at least some of the light output from light sources of other unmanned aerial vehicles in swarm flight, and correct the location error based on the recognized light.

In order to accomplish the above and other objects, the unmanned aerial vehicle according to an embodiment disclosed in the present specification includes a main body; at least one motor provided in the main body; at least one propeller connected to each of the at least one motor; a light emitting module provided in the main body and configured to output light in a three-axis direction; a light reception module provided in the main body and configured to receive light output from some of other unmanned aerial vehicles in swarm flight; a sensing module includes a sensor configured to sense a motion state of an unmanned aerial vehicle; a communication module configured to share location information based on the sensing data of the sensing module with at least an unmanned aerial vehicle that outputs the received light among the other unmanned aerial vehicles; and a processor configured to collect a plurality of shared location information, determine a location error based on the plurality of shared location information, and control the motor to perform a flight to correct the determined location error. Meanwhile, the sensing module includes at least one of a gyroscope, an accelerometer, a magnetometer, a GPS sensor, an image sensor or a barometric pressure sensor.

Meanwhile, the processor determines the location error based on a probability distribution of coordinate information collected from unmanned aerial vehicles arranged on the same axis in the formation of the swarm flight.

In addition, the processor determines the location error based on a probability distribution of coordinate information based on Information sensed by the same type sensor of unmanned aerial vehicles arranged on the same axis in the formation of the swarm flight.

In addition, the processor collects z-axis coordinate information with unmanned aerial vehicles arranged in the same layer in the formation of the swarm flight, and collects x,y axis coordinate information with unmanned aerial vehicles arranged in another layer in the formation of the swarm flight.

Meanwhile, the processor controls the communication module to transmit information on the determined location error to the unmanned aerial vehicle that outputs the received light.

Meanwhile, the light reception module receives output light of a light source corresponding to absolute reference information including fixed coordinate information, and processor determines a current location based on the absolute reference information.

Meanwhile, at least three pairs of the light emitting module and the light reception module are included.

In addition, the pairs of the light emitting module and the light reception module have the same separation distance and arrangement direction of the light emitting module and the light reception module.

Meanwhile, the light emitting module and the light reception module are tiltable.

In order to accomplish the above and other objects, the unmanned aerial vehicle system according to an embodiment disclosed in the present specification includes unmanned aerial vehicles configured to perform swarm flight in a specific formation; wherein the unmanned aerial vehicles include a light emitting module configured to output light in a three-axis direction, a light reception module configured to receive light output from some of other unmanned aerial vehicles in swarm flight, a sensing module includes a sensor configured to sense a motion state, and a communication module configured to share location information based on the sensing data of the sensing module with at least an unmanned aerial vehicle that outputs the received light among the other unmanned aerial vehicles, wherein at least one unmanned aerial vehicle among the unmanned aerial vehicles collects a plurality of shared location information, determines a location error based on the plurality of shared location information, and performs a flight to correct the determined location error.

Meanwhile, the at least one unmanned aerial vehicle determines the location error based on a probability distribution of coordinate information collected from unmanned aerial vehicles arranged on the same axis in the formation of the swarm flight.

In addition, the at least one unmanned aerial vehicle determines the location error based on a probability distribution of coordinate information based on Information sensed by the same type sensor of unmanned aerial vehicles arranged on the same axis in the formation of the swarm flight.

Meanwhile, the at least one unmanned aerial vehicle collects z-axis coordinate information with unmanned aerial vehicles arranged in the same layer in the formation of the swarm flight, and collects x,y axis coordinate information with unmanned aerial vehicles arranged in another layer in the formation of the swarm flight.

Meanwhile, at least one unmanned aerial vehicle among unmanned aerial vehicles arranged in the lowest altitude layer in the formation of the swarm flight receives output light of a light source corresponding to absolute reference information including fixed coordinate information, and determines a current location based on the absolute reference information.

In addition, at least some of the other unmanned aerial vehicles correct the location error based on the unmanned aerial vehicle that has determined the current location based on the absolute reference information.

Meanwhile, other unmanned aerial vehicles correct the location error based on a first unmanned aerial vehicle among unmanned aerial vehicles arranged in the lowest altitude first layer in the formation of the swarm flight, a second unmanned aerial vehicle arranged on a same z-axis as the first unmanned aerial vehicle among the unmanned aerial vehicles arranged on a second layer higher than the first layer, corrects the location error based on the first unmanned aerial vehicle, and other unmanned aerial vehicles correct the location error based on the second unmanned aerial vehicle among unmanned aerial vehicles arranged in the second layer in the formation of the swarm flight.

In addition, the first unmanned aerial vehicle receives output light of a light source corresponding to absolute reference information including fixed coordinate information, and determines a current location based on the absolute reference information.

Meanwhile, wherein unmanned aerial vehicles arranged in the lowest altitude first layer in the formation of the swarm flight receive output light of a light source corresponding to absolute reference information including fixed coordinate information, and determine a current location based on the absolute reference information, and each of unmanned aerial vehicles arranged on a second layer higher than the first layer corrects the location error based on the unmanned aerial vehicle arranged on a same z-axis as the first unmanned aerial of the first layer arranged on the same z-axis.

Meanwhile, unmanned aerial vehicles arranged in a layer of the same altitude correct location error based on any one base unmanned aerial vehicle in the formation of the swarm flight, the base unmanned aerial vehicles adjust the distance between each other in the formation of the swarm flight.

Various other effects of the present invention are directly or suggestively disclosed in the above detailed description of the invention.

It will be apparent that, although the preferred embodiments have been shown and described above, the present invention is not limited to the above-described specific embodiments, and various modifications and variations can be made by those skilled in the art without departing from the gist of the appended claims. Thus, it is intended that the modifications and variations should not be understood independently of the technical spirit or prospect of the present invention.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerial vehicle comprising:
a body;
at least one motor provided in the body;
at least one propeller to couple to the at least one motor;
a light emitting module provided in the body, and configured to output light in a plurality of directions;
a light reception module provided in the body, and configured to receive light output from other aerial vehicles in a swarm flight formation with the aerial vehicle;
a sensing device configured to sense a motion state of the aerial vehicle, and to provide sensing data based on the sensed motion;
a communication device configured to share location information based on the sensing data of the sensing device with at least one of the other aerial vehicles that outputs the light received by the light reception module; and
a processor configured to:
collect a plurality of shared location information,
determine a location error based on the plurality of shared location information, and
control the motor to control a flight to correct the determined location error.

2. The aerial vehicle according to claim 1, wherein the sensing device includes at least one of a gyroscope, an accelerometer, a magnetometer, a GPS sensor, an image sensor or a barometric pressure sensor.

3. The aerial vehicle according to claim 1, wherein the processor is configured to determine the location error based on a probability distribution of coordinate information collected from the aerial vehicles arranged on a same axis in the swarm flight formation.

4. The aerial vehicle according to claim 3, wherein the processor is configured to determine the location error based on a probability distribution of coordinate information based on information sensed by a same type of sensor of the aerial vehicles arranged on the same axis in the swarm flight formation.

5. The aerial vehicle according to claim 3, wherein the processor is configured to collect z-axis coordinate information with the aerial vehicles arranged in same layer in the swarm flight formation, and to collect x,y axis coordinate information with the aerial vehicles arranged in another layer in the swarm flight formation.

6. The aerial vehicle according to claim 1, wherein the processor is configured to control the communication device to transmit information on the determined location error to one of the aerial vehicles that outputs the light received by the reception module.

7. The aerial vehicle according to claim 1, wherein the light reception module is configured to receive light corresponding to absolute reference information including fixed coordinate information, and
the processor is configured to determine a current location based on the absolute reference information.

8. The aerial vehicle according to claim 1,
wherein the aerial vehicle includes at least three pairs of the light emitting module and the light reception module.

9. The aerial vehicle according to claim 8, wherein each of the pairs of the light emitting module and the light reception module have a same separation distance and a same arrangement direction for the light emitting module and the light reception module.

10. The aerial vehicle according to claim 1, wherein the light emitting module and the light reception module are tiltable.

11. An aerial vehicle system comprising:
a plurality of aerial vehicles configured to perform a swarm flight formation;
wherein a first one of the aerial vehicles include a light emitting module configured to output light in a plurality of directions, a light reception module configured to receive light output from other ones of the aerial vehicles in the swarm flight formation, a sensing device configured to sense a motion state and to provide sensing data based on the sensed motion state, and a communication device configured to share location information based on the sensing data of the sensing device with at least one of the aerial vehicles that outputs the light received by the first one of the aerial vehicles,
wherein the first one of the aerial vehicles is configured to:
collect a plurality of shared location information,
determine a location error based on the plurality of shared location information, and
control a flight to correct the determined location error.

12. The aerial vehicle system according to claim 11, wherein the first one of the aerial vehicles is configured to determine the location error based on a probability distribution of coordinate information collected from the aerial vehicles arranged on a same axis in the swarm flight formation.

13. The aerial vehicle system according to claim 12, wherein the first one of the aerial vehicles is configured to determine the location error based on a probability distribution of coordinate information based on information sensed by a same type of sensor of the aerial vehicles arranged on the same axis in the swarm flight formation.

14. The aerial vehicle system according to claim 11, wherein the first one of the aerial vehicles is configured to collect z-axis coordinate information with the aerial vehicles arranged in a same layer in the swarm flight formation, and to collect x,y axis coordinate information with the aerial vehicles arranged in another layer in the swarm flight formation.

15. The aerial vehicle system according to claim 11, wherein at least one aerial vehicle of the plurality of aerial vehicles arranged in a lowest altitude layer in the swarm flight formation is configured to receive light corresponding to absolute reference information including fixed coordinate information, and is configured to determine a current location based on the absolute reference information.

16. The aerial vehicle system according to claim 15, wherein at least one of the other aerial vehicles is configured to correct the location error based on the aerial vehicle that has determined the current location based on the absolute reference information.

17. The aerial vehicle system according to claim 11, wherein other ones of the aerial vehicles are configured to correct the location error based on a first aerial vehicle of the aerial vehicles arranged in a lowest altitude first layer in the swarm flight formation,
a second aerial vehicle arranged on a same z-axis as the first unmanned aerial vehicle among the the aerial vehicles arranged on a second layer higher than the first layer, is configured to correct the location error based on the first unmanned aerial vehicle, and
a third d aerial vehicles is configured to correct the location error based on the second aerial vehicle among the aerial vehicles arranged in the second layer in the swarm flight formation.

18. The aerial vehicle system according to claim 17, wherein the first aerial vehicle is configured to receive light corresponding to absolute reference information including fixed coordinate information, and determine a current location based on the absolute reference information.

19. The aerial vehicle system according to claim 11, wherein the aerial vehicles arranged in a lowest altitude first layer in the swarm flight formation is configured to receive light corresponding to absolute reference information including fixed coordinate information, and to determine a current location based on the absolute reference information, and
each of the aerial vehicles arranged on a second layer higher than the first layer is configured to correct the location error based on the aerial vehicle arranged on a same z-axis as the first aerial vehicle of the first layer arranged on the same z-axis.

20. The aerial vehicle system according to claim 11, wherein the aerial vehicles arranged in a layer of a same altitude correct location error based on any one base aerial vehicle in the swarm flight formation, and
the base aerial vehicle is configured to adjust a distance between other aerial vehicles in the swarm flight formation.
